(19) United States
(12) Patent Application Publication
(10) Pub. No.: US 2026/0203353 A1
(43) Pub. Date: Jul. 16, 2026

(54) METHOD FOR PROVIDING RESULT OF USER UTTERANCE AND ELECTRONIC DEVICE THEREFOR

(71) Applicant: Samsung Electronics Co., Ltd., Suwon-si (KR)

(72) Inventors: Eunkyung LEE, Suwon-si (KR); Kyoungtaek KIM, Suwon-si (KR); Semin PARK, Suwon-si (KR); Jinwoo PARK, Suwon-si (KR); Hyungjin PARK, Suwon-si (KR); Seoyoung SON, Suwon-si (KR); Dayoung CHUNG, Suwon-si (KR); Dohee CHUNG, Suwon-si (KR)

(21) Appl. No.: 19/562,000

(22) Filed: Mar. 10, 2026

Related U.S. Application Data
(63) Continuation of application No. PCT/KR2024/013823, filed on Sep. 11, 2024.

(30) Foreign Application Priority Data
Sep. 15, 2023 (KR) 10-2023-0123287
Feb. 16, 2024 (KR) 10-2024-0022473

(51) Int. Cl. G06F 16/9032; G06F 16/9038

(52) U.S. Cl. CPC G06F 16/90332; G06F 16/9038

(57) ABSTRACT

An electronic device is provided. The electronic device includes a display, memory including one or more storage media, storing instructions, and one or more processors communicatively coupled to the display and the memory, wherein the instructions, when executed by the one or more processors individually or collectively, cause the electronic device to extract a keyword from a user query received from a user, retrieve information related to an application of the electronic device, based on the keyword, to provide the information as a device search result, transmit the user query and the device search result to a server, obtain a server search result related to the user query from the server, generate a first answer by removing information that overlaps with information included in the device search result from the server search result, generate a second answer based on the device search result, and display the first answer and the second answer.

### CROSS-REFERENCE TO RELATED APPLICATION(S)

This application is a continuation application, claiming priority under 35 U.S.C. § 365(c), of an International application No. PCT/KR2024/013823, filed on Sep. 11, 2024, which is based on and claims the benefit of a Korean patent application number 10-2023-0123287, filed on Sep. 15, 2023, in the Ministry of Intellectual Property (MOIP), and of a Korean patent application number 10-2024-0022473, filed on Feb. 16, 2024, in the Ministry of Intellectual Property (MOIP), the disclosure of each of which is incorporated by reference herein in its entirety.

### BACKGROUND

### 1. Field

The disclosure relates to a method for providing results for a user utterance and an electronic device therefor.

### 2. Description of Related Art

With the advancement of digital technology, various types of electronic devices, such as mobile terminals, personal digital assistants (PDAs), electronic organizers, smartphones, tablet personal computers (PCs), or wearable devices, are becoming widely used. These electronic devices are continuously improving their hardware and/or software to support and enhance their functions.

Recently, technologies for understanding language and summarizing or condensing long sentences through large language models (LLMs) have been advancing. Electronic devices obtain resulting data for user inquiries through LLM servers and provide the obtained data to users. However, since the resulting data often contain a vast amount of information, users may need to navigate through the data to find the information they require.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for removing duplicate information from a large amount of resulting data provided based on information retrieved from a server according to a user query and information associated with an application of an electronic device and providing the data in a form convenient for a user to view.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory including one or more storage media, storing instructions, and one or more processors communicatively coupled to the display and the memory, wherein the instructions, when executed by the one or more processors individually or collectively, cause the electronic device to extract a keyword from a user query received from a user, retrieve information related to an application of the electronic device, based on the keyword, to provide the information as a device search result, transmit the user query and the device search result to a server, obtain a server search result related to the user query from the server, generate a first answer by removing information that overlaps with information included in the device search result from the server search result, generate a second answer based on the device search result, and display the first answer and the second answer.

In accordance with another aspect of the disclosure, a method performed by an electronic device is provided. The method includes receiving, by the electronic device, a voice inquiry through a microphone of the electronic device, displaying, by the electronic device, text corresponding to at least a part of the voice inquiry on an execution screen corresponding to a voice assistant application via a display of the electronic device, transmitting, by the electronic device, a text inquiry including at least a portion of the text and additional information related to the voice inquiry and obtained from a designated application other than the voice assistant application, which is selected based on the text, to a server via a communication circuit of the electronic device, receiving, by the electronic device, an answer generated based at least in part on the text inquiry and the additional information from the server via the communication circuit, identifying, by the electronic device, a first text corresponding to the additional information from the answer, obtaining, by the electronic device, a first answer part including a second text, which is different from the first text, from the answer, and, in response to the voice inquiry, displaying, by the electronic device, the first answer part and a second answer part corresponding to the additional information in separate first and second areas, respectively, on the execution screen via the display.

In accordance with another aspect of the disclosure, a method of operating an electronic device is provided. The method includes receiving a voice inquiry including a first intent and a second intent through a microphone, displaying text corresponding to the voice inquiry in a first area of an execution screen corresponding to the first application through the display, transmitting a text inquiry including at least a portion of the text to the server through a communication circuit of the electronic device, receiving an answer generated based on the user inquiry from the server through the communication circuit, identifying a first answer part corresponding to the first intent and a second answer part corresponding to the second intent from the answer, and, in response to the voice inquiry, displaying the first answer part in a second area of the execution screen located below the first area, and the second answer part in a third area of the execution screen located below the second area.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, by the electronic device, a voice inquiry through a microphone of the electronic device, displaying, by the electronic device, text corresponding to at least a part of the voice inquiry on an execution screen corresponding to a voice assistant application via a display of the electronic device, transmitting, by the electronic device, a text inquiry including at least a portion of the text and additional information related to the voice inquiry and obtained from a designated application other than the voice assistant application, which is selected based on the text, to a server via a communication circuit of the electronic device, receiving, by the electronic device, an answer generated based at least in part on the text inquiry and the additional information from the server via the communication circuit, identifying, by the electronic device, a first text corresponding to the additional information from the answer, obtaining, by the electronic device, a first answer part including a second text, which is different from the first text, from the answer, and in response to the voice inquiry, displaying, by the electronic device, the first answer part and a second answer part corresponding to the additional information in separate first and second areas, respectively, on the execution screen via the display.

According to an embodiment, user convenience can be enhanced by configuring the screen layout to suit the display environment of an electronic device, using the vast amount of information obtained through a large language model (LLM).

According to an embodiment, when a server provides resulting data in response to a user query, concise and non-redundant information can be provided by complementing the content generated by the server and the content stored on the electronic device.

According to an embodiment, rather than providing the answer provided by the LLM server as it is, the information structure of the answer can be modified, and the order of the answers can be rearranged by determining the state of the electronic device and the context surrounding the user query.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIGS. 2A and 2B are diagrams illustrating an example of providing an answer to a user query in an electronic device according to various embodiments of the disclosure;

FIG. 3 is a flowchart illustrating an operating method of an electronic device according to an embodiment of the disclosure;

FIG. 4 is a diagram illustrating an example of classifying answers to a user query into a first answer and a second answer and providing them in an electronic device according to an embodiment of the disclosure;

FIG. 5 is a diagram illustrating an example of classifying answers to a user query into a first answer and a second answer and providing them in an electronic device according to an embodiment of the disclosure;

FIG. 6 is a flowchart illustrating an operating method between an electronic device and a server according to an embodiment of the disclosure;

FIG. 7 is a diagram illustrating an example of classifying answers to a user query into a first answer and a second answer and providing them in an electronic device according to an embodiment of the disclosure;

FIGS. 8A and 8B are diagrams illustrating an example of comparing an answer obtained from a server with a displayed answer in an electronic device according to various embodiments of the disclosure;

FIG. 8C is a diagram illustrating an example of reconstructing an answer obtained from a server in an electronic device according to an embodiment of the disclosure;

FIG. 9 is a diagram illustrating an example of processing and providing an answer obtained from a server in an electronic device according to an embodiment of the disclosure;

FIG. 10 is a flowchart illustrating a method of reconstructing an answer obtained from a server in an electronic device according to an embodiment of the disclosure;

FIG. 11A is a diagram illustrating an example of extracting a keyword from a user query and performing a search in an electronic device and a server according to an embodiment of the disclosure;

FIG. 11B is a diagram illustrating an example of a user interface providing an answer to a user query in an electronic device according to an embodiment of the disclosure;

FIG. 12A is a diagram illustrating an example of extracting a keyword from a user query and performing a search in an electronic device and a server according to an embodiment of the disclosure;

FIG. 12B is a diagram illustrating an example of a user interface providing an answer to a user query in an electronic device according to an embodiment of the disclosure;

FIG. 13A is a diagram illustrating an example of extracting a keyword from a user query and performing a search in an electronic device and a server according to an embodiment of the disclosure;

FIG. 13B is a diagram illustrating an example of a user interface providing an answer to a user query in an electronic device according to an embodiment of the disclosure;

FIG. 14 is a diagram illustrating an example of adjusting the order of answers to a user query in an electronic device according to an embodiment of the disclosure; and

FIG. 15 is a block diagram of a generative artificial intelligence (AI) system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

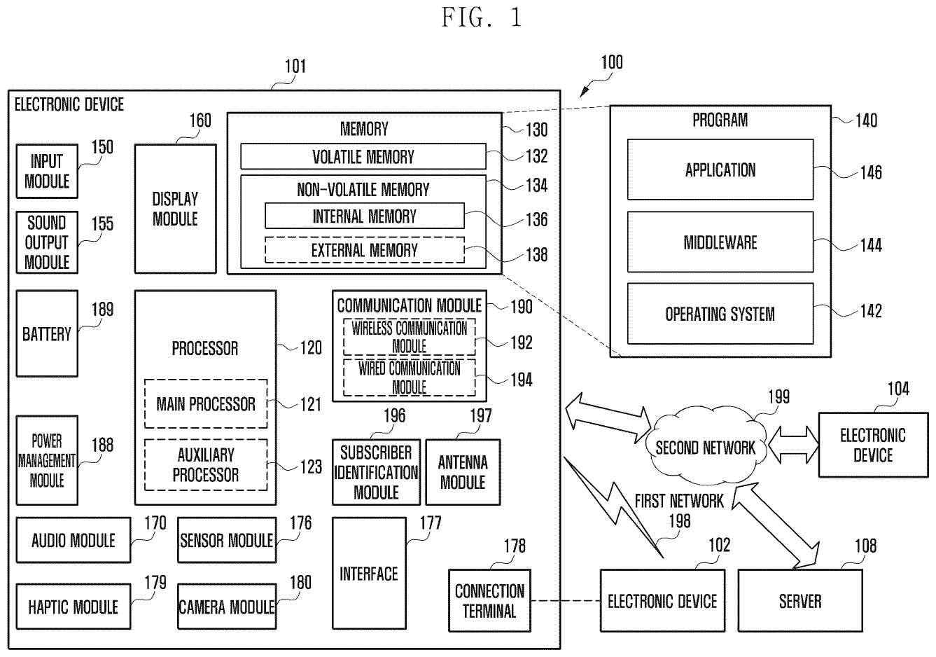

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities mat be separately disposed in any other element. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

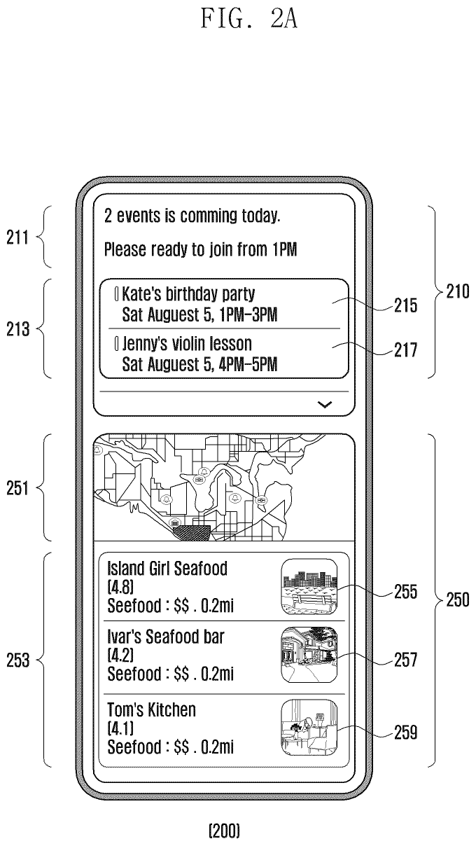

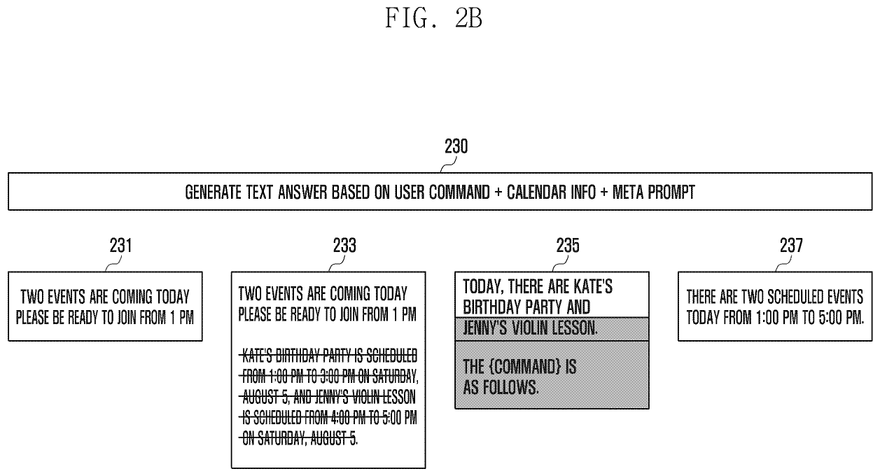

FIGS. 2A and 2B are diagrams illustrating an example of providing an answer to a user query in an electronic device according to various embodiments of the disclosure.

Referring to FIG. 2A, a processor (e.g., the processor 120 in FIG. 1) of an electronic device (e.g., the electronic device 101 in FIG. 1) according to an embodiment may display a user interface 200 including an answer to a user query (user query) on a display (e.g., the display module 160 in FIG. 1). The user query is an input received (or obtained) from a user, and may include, for example, not only a question (in the form of an interrogative sentence), but also a request, a list of simple words, and/or a combination thereof. The user query may include a voice input (e.g., user utterance) received through a microphone (e.g., the input module 150 in FIG. 1) or a text input via a keypad. The processor 120 may receive the user query from the user and transmit the received query to an intelligent server (e.g., the server 108 in FIG. 1).

The server 108 may include a large language model (LLM) server or an artificial intelligence (AI) server employing LLM technology. In response to the user query received from the electronic device 101, the server 108 may generate a plan for performing a task corresponding to the user query, or a result of performing an operation according to the plan. The plan may include, for example, multiple operations for performing a task corresponding to the user query and multiple concepts related to the multiple operations. The concepts may define parameters input to execute the multiple operations or resulting values output by the execution of the multiple operations. The plan may include association information between the multiple operations and the multiple concepts.

The plan may be generated by an artificial intelligence (AI) system. The AI system may be a rule-based system or a neural network-based system (e.g., a feedforward neural network (FNN) or a recurrent neural network (RNN)). Alternatively, it may be a combination of the above or another AI system. According to an embodiment, the plan may be selected from a set of predefined plans or may be generated in real time in response to a user request. For example, the artificial intelligence system may select at least one plan from a plurality of predefined plans.

According to an embodiment, the processor 120 may extract (or identify) keywords from the user query and, based on the extracted keywords, retrieve information stored in memory (e.g., the memory 130 in FIG. 1), a cloud server, or an external device (e.g., an IoT device) connected to the electronic device 101. In the case where information is stored on a cloud server under the user account of the electronic device 101, the processor 120 may retrieve the information stored in the cloud server, based on the extracted keywords. The processor 120 may obtain information stored on an external device connected to the electronic device 101 and retrieve the information stored on the external device, based on the extracted keywords.

For example, the stored information may include information registered (or stored) in an application (e.g., a health application, a messaging application, etc.) installed on the electronic device 101. For example, if the keyword is “schedule,” the processor 120 may retrieve the schedule from a schedule application. The processor 120 may transmit the user query and/or the retrieved information to the server 108. The retrieved information may be transmitted to the server 108 as a device search result. Alternatively, the information stored in the memory 130 may be previously stored (or registered) in the server 108. In this case, the processor 120 may transmit only the user query to the server 108 without performing a search based on the keyword on the memory 130.

The processor 120 may analyze the user query to determine which domain the user utterance is associated with, and retrieve information stored in the memory 130 based on this. For example, if the user utterance is “Find John in the phone book,” the processor 120 may identify the phone book as the domain associated with the user utterance, and transmit a query to find John's phone number to the phone book domain among a plurality of applications installed on the electronic device 110.

According to an embodiment, the processor 120 may retrieve information obtained from an external device connected to the electronic device 101 using the keyword. The external device may be a device used with the same user account as the electronic device 101, and may be, for example, a wearable device, a laptop, a computer, or an Internet of Things (IoTs) device (e.g., a Bluetooth speaker, a television (TV), or a refrigerator). The processor 120 may retrieve information stored on the external device or information obtained from the external device, as well as the information stored in the memory 130, using the keyword. The processor 120 may transmit the retrieved information to the server 108 as a device search result.

The processor 120 may obtain a server search result from the server 108 and remove, from the server search result, information that overlaps with the information included in the device search result, thereby generating a first answer and a second answer (e.g., fine-tuning). For example, the processor 120 may remove duplicate information (types: text, images, or videos) by combining and analyzing content from multiple devices, or by analyzing the content of a single device (e.g., the server 108 or the electronic device 101). The server search result may be generated by the server 108 in response to the user query and may include a large amount of resulting data. Furthermore, the server search result may include a search result generated by the server 108 and a device search result retrieved from an application of the electronic device 101. The device search result may include not only search results from the electronic device 101, such as application data, but also information obtained from a cloud server (e.g., when application data is stored on a cloud server) or an external device.

Alternatively, the server search result may include information (e.g., usage history, conversation history, or search history) within the electronic device 101 in addition to the search result from the server 108. The server search result generated by the server 108 may partially overlap with the device search results retrieved by the electronic device 101. Therefore, the processor 120 may remove duplicate information from the server search result to construct a first answer as a direct answer to the user query and a second answer as an additional (or reference, auxiliary, or related) answer to the user query.

The processor 120 may identify a first text corresponding to the device search result from the server search result. The processor 120 may obtain a first answer part including a second text, which is different from the first text, from the server search result. For example, the first answer may be a highly accurate answer directly related to the user query, and the second answer may be an answer inferred by the server 108 for the user query.

According to an embodiment, the processor 120 may analyze the server search result to determine the answer type, distinguish between display text and read text based on the answer type, and remove the read text to classify it into a first answer and a second answer. The display text and the read text may have different text lengths. For example, if the text included in the read text is 20 characters long, the text included in the display text may be 100 characters or longer. The read text is text read aloud by the electronic device 101 and may be generated simpler than the display text. The display text refers to text displayed on the screen of the electronic device 101 and may include more detailed information than the display text. When transmitting the user query to the server 108, the processor 120 may request that the type of text be distinguished and transmitted (e.g., meta prompt), or may analyze the server search result to determine the answer type of the text.

Referring to the user interface 200, the processor 120 may provide a first answer 210 and a second answer 250 in response to a user query (e.g., “What is today's schedule?”). The first answer 210 may include a text answer 211 of the server 108 in response to the user query and application search information 213 provided by the electronic device 101. The application search information 213 may include first schedule information 215 and second schedule information 217. Since the user query is a question about today's schedule, the application search information 213 may be retrieved for “today” and “schedule” from the schedule application installed in the electronic device 101. When the first schedule information 215 is selected by the user, the processor 120 may execute a schedule application and provide an execution screen of the schedule application including the first schedule information 215.

The second answer 250 is an answer inferred by the server 108. Since today's schedule includes a birthday party, it may identify the user's intent and provide the location where the birthday party will be held. The second answer 250 may include a map image 251 and restaurant information 253. The map image 251 may indicate the location of the restaurant included in the restaurant information 253. The restaurant information 253 may include a first restaurant 255, a second restaurant 257, and a third restaurant 259. The restaurant information 253 may include the names of the first restaurant 255 to the third restaurant 259, the food sold at the restaurants, the restaurant locations, the restaurant rating, or the restaurant images. When the second restaurant 257 is selected by the user, the processor 120 may execute an integrated search application (or map application) and provide an execution screen of the integrated search application including the second restaurant 257.

The processor 120 may display the first answer 210 in a first area of the display module 160 and the second answer 250 in a second area of the display module 160. The first area may be positioned (or arranged) above the second area on the display module 160. Since users tend to first view the answer displayed at the top when looking at answers to their questions, the processor 120 may display the first answer 210 in an area above the second answer 250 on the display module 160.

The processor 120 may display at least one image or at least one piece of detailed information corresponding to the name of at least one item as the first answer 210. The processor 120 may display text (e.g., the text answer 211) summarizing detailed information other than the name of at least one item. The processor 120 may display text indicating the number of at least one item as the first answer 210. The processor 120 may display the application search information 213 and the text answer 211 in different first and second formats, respectively. For example, the first format may be text, and the second format may be an image (or video).

Referring to FIG. 2B, the processor 120 may analyze a user utterance (e.g., user command) obtained as a user query to determine which domain (e.g., calendar info) the user query is associated with, and may retrieve (230) a schedule corresponding to today's date from the schedule application. The processor 120 may transmit, to the server 108, the information obtained from the schedule application as a device search result together with the user query. The processor 120 may obtain a server search result from the server 108. For example, if the user query is “What is today's schedule?,” a plurality of answer texts 231, 233, 235, and 237 may be received from the server. The first answer text 231 may include a descriptive sentence, “Two events are coming today,” which summarizes the device search result, and an advisory sentence, “Please be ready to join from 1 PM,” which is generated by utilizing the time information, “1 PM to 3 PM,” and “4 PM to 5 PM,” which are partial details of today's schedule from the device search result. When the first answer text 231 is received, the processor 120 may determine that there is no duplicate content with the device search result and generate the first answer text 231 as the first answer. The device search results may include information retrieved from the memory 130 of the electronic device 101, a cloud server registered with the user account of the electronic device 101, or an external device, based on the user query or the keywords extracted from the user query.

The second answer text 233 may include, in addition to the descriptive sentence summarizing the device search result and the advisory sentence generated by utilizing a part of the device search result, as represented in the first answer text 231, text corresponding to the device search result (or a sentence obtained by simply converting the device search result into text). When the second answer text 233 is received, the processor 120 may generate the remainder after removing duplicate content with the device search result as the first answer.

The third answer text 235 may include a proper noun, such as a name, in addition to the descriptive sentence summarizing the device search result. In this case, the processor 120 may add “~is as follows,” an introductory sentence that may be universally used for various types of user queries, to the text (e.g., “Today's schedule”) corresponding to the user query, thereby generating a first answer as an introductory sentence by replacing the third answer text 235.

An electronic device according to an embodiment of the disclosure may include a display, a processor, and memory, and instructions stored in memory may, when executed by the processor, cause the electronic device to extract a keyword from a user query received from a user, retrieve information related to an application of the electronic device, based on the keyword, to provide the information as a device search result, transmit the user query and the device search result to a server 108, obtain a server search result related to the user query from the server, generate a first answer by removing information that overlaps with information included in the device search result from the server search result, generate a second answer based on the device search result, and display the first answer and the second answer.

The instructions, when executed by the processor, may cause the electronic device to obtain information, as the device search result, retrieved from an external device associated with the electronic device using the keyword.

The instructions, when executed by the processor, may cause the electronic device to display the first answer and the second answer in separate first and second areas, respectively, on the display.

The instructions, when executed by the processor, may cause the electronic device to display the first answer in the first area and display the second answer in the second area such that the first area is positioned above the second area on the display.

The instructions, when executed by the processor, may cause the electronic device to analyze the user query to identify a user intent and, based on a plurality of identified user intents, determine the order of answers in the server search result according to the order in which a user requested the answers.

The instructions, when executed by the processor, may cause the electronic device to analyze the server search result to determine an answer type, distinguish display text and read text, based on the answer type, and remove the read text to generate the first answer.

The instructions, when executed by the processor, may cause the electronic device to collect the user query, an answer displayed in response to the user query, and an additional user response to the answer, and learn the collected user query, the collected answer, and the collected additional user response to generate an answer reconstruction model.

The instructions, when executed by the processor, may cause the electronic device to generate the first answer and the second answer using the answer reconstruction model.

The instructions, when executed by the processor, may cause the electronic device to update the answer reconstruction model when a new user query is received.

The instructions, when executed by the processor, may cause the electronic device to generate the first answer as a natural language sentence, and generate the second answer in a view type.

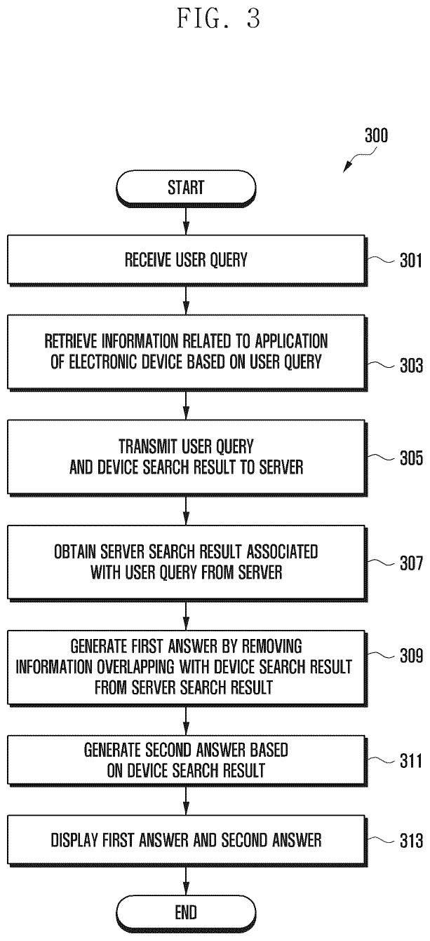

FIG. 3 is a flowchart 300 illustrating an operating method of an electronic device according to an embodiment of the disclosure.

Referring to FIG. 3, in operation 301, a processor (e.g., the processor 120 in FIG. 1) of an electronic device (e.g., the electronic device 101 in FIG. 1) according to an embodiment may receive a user query. The user query is an input received (or obtained) from a user, and may include, for example, not only a question (in the form of an interrogative sentence), but also a request, a list of simple words, and/or a combination thereof. The user query may include a voice input (e.g., user utterance) received through a microphone (e.g., the input module 150 in FIG. 1) or a text input via a keypad. For example, the processor 120 may first receive a designated voice wake-up word (e.g., “wake up”) from the user, or may receive the voice input after selecting a configured button. The processor 120 may convert the voice input into text and display it on a display (e.g., the display module 160 in FIG. 1). Alternatively, the processor 120 may receive the text input via a keypad after selecting a configured button. The processor 120 may display the text input on the display module 160.

In operation 303, the processor 120 may retrieve information related to an application of the electronic device 101, based on the user query. The processor 120 may determine which part of the memory (e.g., the memory 130 in FIG. 1) to retrieve based on the utterance (query). For example, when a user query such as “Tell me my schedule for today” is received, the processor 120 may retrieve the schedule from the “schedule application.” When a user query such as “Turn on the air conditioner” is received, the processor 120 may analyze the corresponding utterance and retrieve the air conditioner from the “SmartThings (IOT) application.” Similarly, when a user query such as “Adjust the living room brightness” is received, the processor 120 may analyze the corresponding utterance and retrieve lighting from the “SmartThings (IOT) application.” Retrieving information related to the application may mean retrieving information related to the application not only from the information stored in the memory 130 of the electronic device 101, but also from information stored on a cloud server registered with the user account of the electronic device 101 or an external device connected to the electronic device 101.

According to an embodiment, the processor 120 may extract keywords from the user query. If the user query is a voice input, the processor 120 may convert (or transform) the voice input into text using speech recognition technology and extract (or identify) keywords from the converted text. Alternatively, if the user query is a text input, the processor 120 may extract (or identify) keywords from the text input. For example, if a user query such as “What's my schedule today?” is received, the processor 120 may extract “today” and “schedule” as keywords.

The processor 120 may determine which part to retrieve from the memory 130, based on the utterance (query). The processor 120 may retrieve information stored in the memory 130 using the keywords. The information stored in the memory 130 may include information stored (or registered) on the electronic device 101. The processor 120 may retrieve, based on the keywords or the user utterance (query), information stored in the memory 130, information stored on a cloud server registered with the user account of the electronic device 101, or information stored on an external device connected to the electronic device 101. For example, the processor 120 may retrieve information stored (or registered) in an application installed in the electronic device 101 using the keywords. For example, if the keyword is “birthday,” the processor 120 may retrieve the keyword “birthday” from a schedule application or a messaging (or messenger) application.

Furthermore, the processor 120 may retrieve information obtained from an external device connected (or having been previously connected) to the electronic device 101 using the keywords. The external device may be a device used with the same user account as the electronic device 101 and may be, for example, a wearable device, a laptop, a computer, or an IoT device. The processor 120 may retrieve not only information stored in the memory 130, but also information stored on the external device or information obtained from the external device, using the keywords. The processor 120 may obtain information retrieved using the keywords from the application or the external device as a device search result.

According to an embodiment, the processor 120 may periodically (e.g., daily, weekly, or monthly), selectively (e.g., upon user request), or in real time (e.g., whenever new information is stored) upload (or store) information stored in the memory 130 to an intelligent server (e.g., the server 108 in FIG. 1). Furthermore, the processor may periodically (e.g., daily, weekly, or monthly), selectively (e.g., upon user request), or in real time (e.g., whenever new information is stored) obtain information stored (or registered) on the external device and upload (or store) the obtained information to the server 108. If the information stored on the electronic device 101 or the information obtained from the external device is the information stored in the server 108, operation 305 may be omitted.

In operation 305, the processor 120 may transmit the user query and the device search result to the server 108. The device search result may include information retrieved in operation 303. The device search result may include information retrieved from the memory 130 of the electronic device 101, the cloud server registered with the user account of the electronic device 101, or the external device based on the user query or keywords extracted from the user query. The processor 120 may transmit the user query and/or the device search result to the server 108 via a communication module (e.g., the communication module 190 in FIG. 1). If information retrieved using the keywords does not exist, the processor 120 may transmit only the user query to the server 108. Alternatively, if the server 108 already stores information stored on the electronic device 101 or the external device, the processor 120 may transmit only the user query to the server 108. This is merely an implementation issue and the disclosure is not limited thereto.

The server 108 may perform a search operation based on the user query. For example, if the user query is “Let me know the popular tourist attractions in Seattle,” the server 108 may perform a search on the integrated search server using “Seattle,” “popular,” and “tourist attractions” and generate a list of Seattle tourist attractions as a server search result. Furthermore, the server 108 may recognize the user's intent from the user query and include locations that align with the user's intent as recommended places in the server search result. For example, the server 108 may include locations such as restaurants or cafes near tourist attractions as recommended places in the search result. The server 108 may distinguish between a list of tourist attractions corresponding to the direct answer to the user query and a list of recommended attractions inferred based on the user's intent, and transmit them to the electronic device 101. Furthermore, the server 108 may also perform a search operation, based on the user query and the device search result.

The server 108 may perform a search operation, based on the user query and the device search result. For example, if the user query is “Recommend an air purifier,” the server 108 may retrieve “air purifier” from the integrated search server and generate a list of air purifiers as a search result. Furthermore, the server 108 may recognize the user's intent from the user query and include, in the search result, a table comparing and analyzing air purifiers that meet the user's intent. For example, the server 108 may include a table comparing the air purifier currently used by the user with popular air purifiers in the search result. The server 108 may distinguish between an air purifier list, which is a direct answer to the user query, and an air purifier comparison table, which is inferred based on the user's intent, and transmit them to the electronic device 101.

In operation 307, the processor 120 may obtain a server search result associated with the user query from the server 108. The server search result includes information generated (or retrieved) by the server 108 and may also include the device search result retrieved by the electronic device 101. Therefore, a part of the server search result may overlap with the device search result. The server search result may include a direct answer to the user query and an answer inferred based on the user's intent analyzed from the user query. The server search result may include at least one of text, an image, or a video.

In operation 309, the processor 120 may remove information that overlaps with the device search result from the server search result to generate a first answer. The processor 120 may determine whether duplicate information exists in the server search result. For example, if the server search result includes a result generated by the server 108 and a device search result retrieved by the electronic device 101, the result generated by the server 108 and the device search result retrieved by the electronic device 101 may partially overlap. If duplicate information exists, the processor 120 may remove the duplicate information with the device search result from the server search result and generate a first answer to be provided to the user.

In operation 311, the processor 120 may generate a second answer based on the device search result. For example, the processor 120 may configure a direct answer to the user query as a first answer, and an answer inferred by the server 108 based on the user's intent as a second answer. The first answer and the second answer may be configured in different formats. For example, the first answer may be configured as text, and the second answer may be configured as an image. The second answer may include some of the information contained in the first answer. Since users tend to prefer viewing to reading, the second answer may be configured in a display format to reflect the user's needs.

According to an embodiment, the processor 120 may analyze the search result to determine the answer type, distinguish between the display text and the read text based on the answer type, and classify the result into a first answer and a second answer by removing the read text. According to an embodiment, the processor 120 may collect a user query, an answer displayed in response to the user query, and an additional user response to the answer. The processor 120 may learn the user query, the displayed answer, and the additional user response to generate an answer reconstruction model. The processor 120 may classify the first answer and the second answer using the answer reconstruction model. When a new user query is received, the processor 120 may update the answer reconstruction model.

In operation 313, the processor 120 may display the first answer and the second answer on the display module 160. For example, the processor 120 may display the first answer in a first area of the display module 160 and the second answer in a second area of the display module 160. The first area may be positioned (or arranged) above the second area on the display module 160. Since users tend to first view the answer displayed at the top when looking at answers to their questions, the processor 120 may display the first answer in an area above the second answer on the display module 160.

The processor 120 may detect a user input in either the first answer or the second answer. For example, if a user input for selecting one item of the first answer is detected, the processor 120 may execute an application corresponding to the selected item and display an execution screen of the executed application.

For example, if the search result includes the content “You have a meeting with AA at 11:00 AM tomorrow and lunch with BB at 2:00 PM,” the text may be summarized as “You have meetings tomorrow at 11:00 AM and 2:00 PM.” Furthermore, the processor 120 may configure each schedule information (e.g., AA meeting at 11:00 AM and BB lunch at 2:00 PM) as an image to generate it as a view type (or information). The processor 120 may analyze the server search result and generate a first answer in a text type and a second answer in a view type.

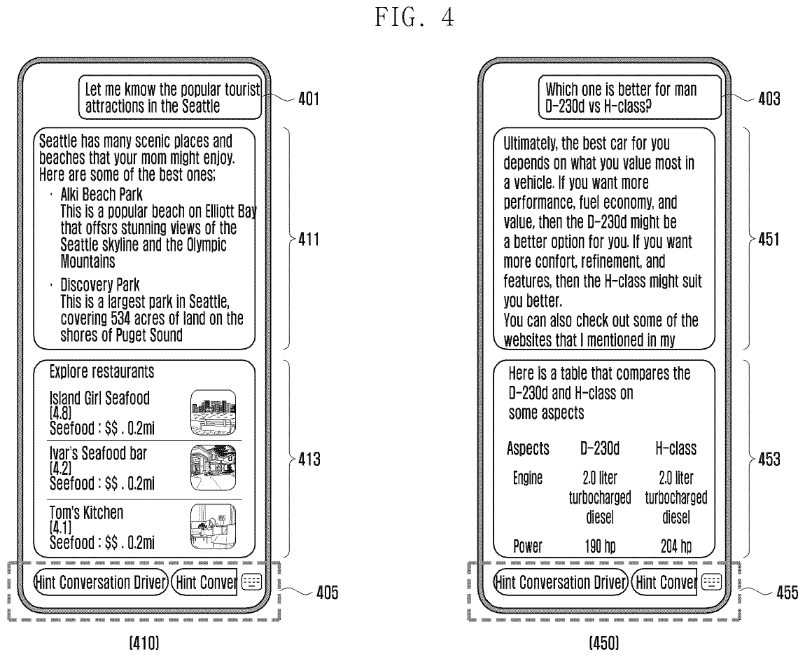

FIG. 4 is a diagram illustrating an example of classifying answers to a user query into a first answer and a second answer and providing them in an electronic device according to an embodiment of the disclosure.

Referring to FIG. 4, a processor (e.g., the processor 120 in FIG. 1) of an electronic device (e.g., the electronic device 101 in FIG. 1) according to an embodiment may receive a first user query 401 and display a first user interface 410 that provides answers 411 and 413 to the first user query 401 on a display (e.g., the display module 160 in FIG. 1). The processor 120 may obtain a voice input (e.g., user utterance) received through a microphone (e.g., the input module 150 in FIG. 1) as the first user query 401. The processor 120 may first receive a designated voice wake-up word (e.g., “wake up”) from the user, or may receive the voice input after selecting a configured button. The processor 120 may convert the voice input into text and display the converted text as the first user query 401 on the display module 160. Alternatively, the processor 120 may receive the text input via a keypad after selecting a configured button and display the text input as the first user query 401 on the display module 160. The processor 120 may transmit the user query 401 to an intelligent server (e.g., the server 108 in FIG. 1) via a communication module (e.g., the communication module 190 in FIG. 1).

The processor 120 may analyze the user query 401 to determine a domain (e.g., application) to perform a search and retrieve information stored in the determined domain. Alternatively, the processor 120 may extract (or identify) keywords from the user query 401 and, based on the extracted keywords or the user query 401, retrieve information stored on the electronic device 101, information stored on a cloud server registered with the user account of the electronic device 101, or information stored on an external device connected to the electronic device 101. For example, the processor 120 may extract keywords such as “popular,” “tourist attractions,” and “Seattle” from the first user query 401 and retrieve information stored (or registered) in, for example, a schedule application, a messaging (messenger) application, or an SNS application using the extracted keywords. Furthermore, the processor 120 may perform a search on an external device that has the same user account as the electronic device 101 using the keywords. When transmitting the first user query 401, the processor 120 may transmit the information retrieved using the keywords to the server 108 as a device search result. If no information is retrieved using the keywords, the processor 120 may transmit only the first user query 401 to the server 108.

The server 108 may perform a search operation based on the first user query 401 and/or the device search result. For example, the server 108 may retrieve “Seattle,” “popular,” and “tourist attractions” from the integrated search server and generate a list of Seattle tourist attractions as a search result. Furthermore, the server 108 may identify a user's intent from the first user query 401 and retrieve recommended information that aligns with the user's intent. For example, the server 108 may include places such as restaurants or cafes near tourist attractions as recommended places in the search result. The server 108 may distinguish between a list of tourist attractions corresponding to the direct answer to the user query and a list of recommended attractions inferred based on the user's intent, and transmit them to the electronic device 101.

The processor 120 may receive the server search result from the server 108 and remove duplicate information with the device search result from the server search result to generate a first answer 411 and a second answer 413. Referring to the first user interface 410, the first answer 411 is a direct answer to the first user query 401 and may be configured as an accurate answer to the user's question. The second answer 413 is an answer inferred by the server 108 based on the user's intent analyzed from the first user query 401, and may be configured as information that the user may reference, supplement, relate, or add. For example, the first answer 411 may be configured as a text type (e.g., a reading type), and the second answer 413 may be configured as an image or video type (e.g., a display type). The display types of the first answer 411 and the second answer 413 may be different, which is intended to aid understanding of the disclosure and does not limit the disclosure.

The processor 120 may display the first answer 411 in a first area of the display module 160 and display the second answer 413 in a second area of the display module 160, as shown in the first user interface 410. The first area may be positioned (or arranged) above the second area of the display module 160. The first area may be positioned directly below the first user query 401 on the display module 160, and the second area may be arranged below the first area. According to an embodiment, the next query object 405 following the first answer 411 or the second answer 413 may be further displayed below the second answer 413. The next query object 405 may be a query text that is expected to be requested (questioned) (e.g., the next user query) later by a user who has received the first answer 411 or the second answer 413. The processor 120 may detect a user input in either the first answer or the second answer. For example, if a user input for selecting the first answer 411 is detected, the processor 120 may execute an application related to the first answer 411 and provide the first answer 411 in more detail through the execution screen of the executed application.

According to an embodiment, the first user interface 410 may further include an object (e.g., a button) for outputting voice for the first answer 411 or/and the second answer 413. When the user selects a voice output object, the processor 120 may convert the text of the first answer 411 or/and the second answer 413 into voice and output the converted voice through a speaker (e.g., the audio output module 155 in FIG. 1) or an external speaker (e.g., earphones connected to the electronic device 101).

The processor 120 may receive a second user query 403 and display a second user interface 450 that provides answers 451 and 453 to the second user query 403 on the display module 160. The second user query 403 may be a user's voice input converted into text and displayed, or a text input displayed on the display module 160. The processor 120 may transmit the second user query 403 and/or the device search result to the server 108 and receive a server search result from the server 108. The server search result received from the server 108 may partially overlap with the device search result. The device search result may include information retrieved from the memory 130 of the electronic device 101, a cloud server registered with the user account of the electronic device 101, or an external device, based on the user query or keywords extracted from the user query.

The processor 120 may remove information that overlaps the device search result from the server search result, thereby generating a first answer 451 and a second answer 453. The first answer 451 is a direct answer to the second user query 403 and may be configured as an accurate answer to the user's question. The second answer 453 may be a table of detailed information regarding the second user query 403. The second answer 453 may be obtained by summarizing the first answer 451 and configured in a format convenient for the user to view. The processor 120 may display the first answer 451 in a first area of the display module 160 and the second answer 453 in a second area of the display module 160, as shown in the second user interface 450. The first area may be positioned (or arranged) above the second area on the display module 160. According to an embodiment, an execution item object 455 related to the first answer 451 or the second answer 453 may be further displayed below the second answer 453. For example, if a user input for selecting the second answer 453 is detected, the processor 120 may execute an application related to the second answer 453 and provide the second answer 453 in more detail through the execution screen of the executed application.

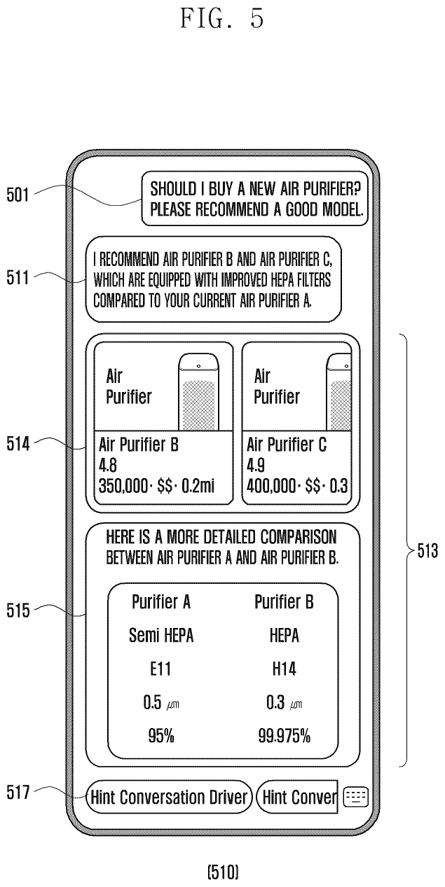

FIG. 5 is a diagram illustrating an example of classifying answers to a user query into a first answer and a second answer and providing them in an electronic device according to an embodiment of the disclosure.

Referring to FIG. 5, a processor (e.g., the processor 120 in FIG. 1) of an electronic device (e.g., the electronic device 101 in FIG. 1) according to an embodiment may receive a user query 501 and display a user interface 510 that provides answers 511 and 513 in response to the user query 501 on a display (e.g., the display module 160 in FIG. 1). The user query 501 may be a user's voice input converted into text or a text input displayed on the display module 160. The processor 120 may extract (or identify) keywords such as “air purifier” and “recommend” from the user query 501. For example, the processor 120 may retrieve “air purifier” from an IoT application and transmit a search result as a device search result to the server 108. The processor 120 may transmit the user query 501 or/and the device search result to the server 108. The device search result may include information retrieved from the memory 130 of the electronic device 101, a cloud server registered with the user account of the electronic device 101, or an external device, based on the user query or keywords extracted from the user query.

The processor 120 may receive a server search result from the server 108. The server search result received from the server 108 may partially overlap with the device search result. The processor 120 may remove information that overlaps with the device search result from the server search result to generate a first answer 511 and a second answer 513. The first answer 511 is a direct answer to the user query 501 and may be configured as an accurate answer to the user's question. The second answer 513 may be obtained by summarizing the first answer 511 or configured in a table format convenient for the user to view. For example, the second answer 513 may include a first table 514 and a second table 515. The first table 514 is a table that briefly compares two air purifiers, and may include, for example, photos, names, user ratings, and prices of the air purifiers. The second table 515 is a table that provides a detailed comparison of the specifications of the two air purifiers, and may include the names of the air purifiers, detailed filters, and the degree of air quality improvement. For example, the first answer 511 may be configured in a text type (e.g., a reading type), while the second answer 513 may be organized in an image or video type (e.g., a display type).

The processor 120 may display the first answer 511 in a first area of the display module 160, and the second answer 513 in a second area of the display module 160, as shown in the user interface 510. The first area may be positioned (or arranged) above the second area of the display module 160. According to an embodiment, an execution item object 517 related to the first answer 511 or the second answer 513 may be further displayed below the second answer 513.

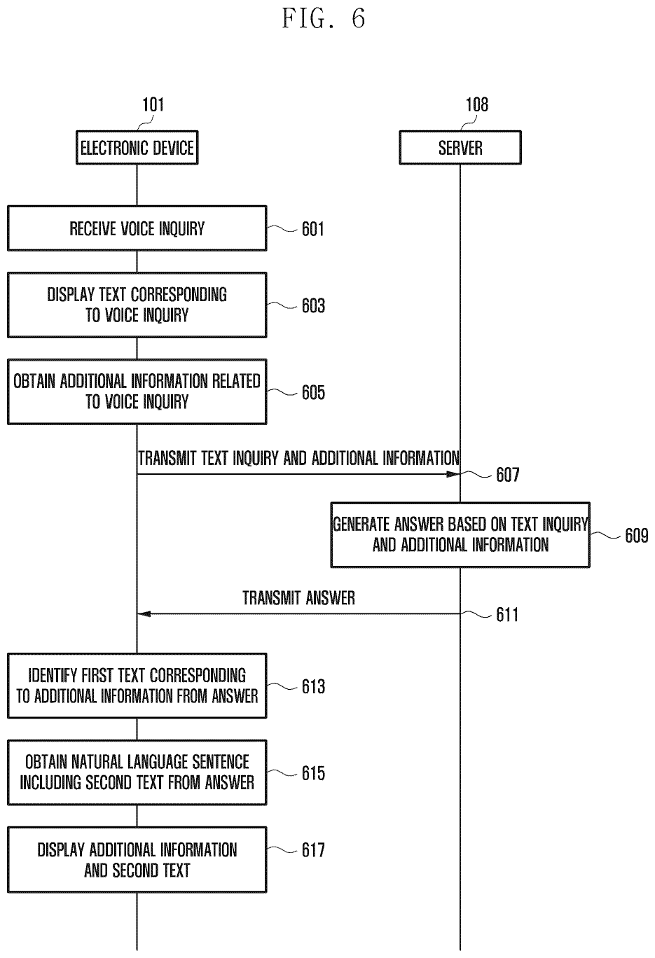

FIG. 6 is a flowchart illustrating an operating method between an electronic device and a server according to an embodiment of the disclosure.

Referring to FIG. 6, in operation 601, an electronic device (e.g., the electronic device 101 in FIG. 1) according to an embodiment may receive a voice inquiry. The voice inquiry is an input received (or obtained) from the user, and may include, for example, not only a question (in the form of an interrogative sentence), but also a request, a list of simple words, and/or a combination thereof. The electronic device 101 may receive the voice inquiry via a microphone (e.g., the input module 150 in FIG. 1).

In operation 603, the electronic device 101 may display text corresponding to the voice inquiry on a display (e.g., the display module 160 in FIG. 1). The electronic device 101 may display the text corresponding to the voice inquiry on an execution screen corresponding to a voice assistant application.

In operation 605, the electronic device 101 may obtain additional information related to the voice inquiry. For example, the electronic device 101 may obtain a text inquiry including at least a portion of the text, and additional information related to the voice inquiry, which is obtained from a designated application other than the voice assistant application, selected based on the text. The other designated application may correspond to an application such as a contact application or a scheduler, which is different from the voice assistant application.

In operation 607, the electronic device 101 may transmit the text inquiry and the additional information to an intelligent server (e.g., the server 108 in FIG. 1). The electronic device 101 may transmit the text inquiry and the additional information to the server 108 via a communication circuit (e.g., the communication module 190 in FIG. 1).

In operation 609, the server 108 may generate an answer, based on the text inquiry and the additional information. The server 108 may include an LLM server or an artificial intelligence server to which large language model technology is applied. The server 108 may retrieve the text inquiry and the additional information and generate the retrieved result as an answer.

In operation 611, the server 108 may transmit the generated answer (e.g., a server search result) to the electronic device 101.

In operation 613, the electronic device 101 may identify a first text corresponding to the additional information from the answer.

In operation 615, the electronic device 101 may obtain a natural language sentence including a second text, which is different from the first text, from the answer.

In operation 617, the electronic device 101 may display the additional information and the second text in response to the voice inquiry. The electronic device 101 may display, on the display, the additional information and the second text in separate first and second areas of the execution screen of the voice assistant application, respectively. The electronic device 101 may display the second area, where the second text is displayed, above the first area, where the additional information is displayed. The electronic device 101 may display at least one image or at least one piece of detailed information corresponding to the name of at least one item included in the first text as a part of the additional information (e.g., the first answer 210 in FIG. 2A). The electronic device 101 may display text (e.g., the text answer 211 in FIG. 2A) obtained by summarizing other detailed information, excluding the name of at least one item, as a part of the second text. The electronic device 101 may display text indicating the number of at least one item as a part of the second text. The electronic device 101 may display the additional information (e.g., the application search information 213 in FIG. 2A) and the second text (e.g., the text answer 211 in FIG. 2A) in different first and second formats, respectively. For example, the first format may be text, and the second format may be an image (or video).

The electronic device 101 may output audio corresponding to the second text at least once to the outside of the electronic device while the second text is displayed.

The designated application may include a scheduler, and the electronic device 101 may transmit the user's schedule information obtained through the scheduler, which satisfies a specific condition included in the voice inquiry, to the server 108 as at least part of the additional information, and display text obtained by summarizing the schedule information as a part of the second text.

According to an embodiment, the electronic device 101 may receive a voice inquiry including a first intent and a second intent through a microphone 150, display text corresponding to the voice inquiry in a first area of an execution screen corresponding to the first application through the display, transmit a text inquiry including at least a part of the text to the server through the communication circuit, receive an answer generated based on the user inquiry from the server through the communication circuit, identify a first answer part corresponding to the first intent and a second answer part corresponding to the second intent from the answer, and, in response to the voice inquiry, display the first answer part in a second area of the execution screen located below the first area, and the second answer part in a third area of the execution screen located below the second area.

The electronic device 101 may display the first answer part and the second answer part through the second area and the third area, respectively, based at least in part on the first answer part not requesting additional information related to the voice inquiry and the second answer part requesting the additional information.

The electronic device 101 may analyze the text included in the answer to retrieve identical or similar text between the answer and the text of the additional information. The electronic device 101 may determine whether an image or video included in the answer is identical or similar to an image or video included in the additional information.

According to an embodiment, the processor (e.g., the processor 120 in FIG. 1) of the electronic device 101 may analyze the user query to identify a user intent and, if there are a plurality of identified user intents, determine the order of the answers in the search result based on the order in which the user requested the answers. For example, if the user sequentially makes a first request and a second request, the processor 120 may provide the answer to the first request as a first answer and the answer to the second request as a second answer. That is, if the user makes multiple requests at once, the processor 120 may determine the order of the answers such that the first requested answer is displayed first as the first answer at the top (e.g., in the first area), and the next requested answer is displayed as the second answer below the first answer (e.g., in the second area).

According to an embodiment, the processor 120 may analyze the user query to identify a user intent and, based on the identified user intent, determine whether the user requests an additional response from the search result. The user's request for an additional response may require reconfirmation of the user because the user's query does not include essential parameters for performing the search operation. The processor 120 may provide an answer for which the user does not request an additional response as the first answer, and an answer for which the user requests an additional response as the second answer. If the user intent is not recognized and a user's reconfirmation is required, the processor 120 may display the answer that does not require the user's reconfirmation above the answer that requires the user's reconfirmation (e.g., in the first area) on the display module 160.

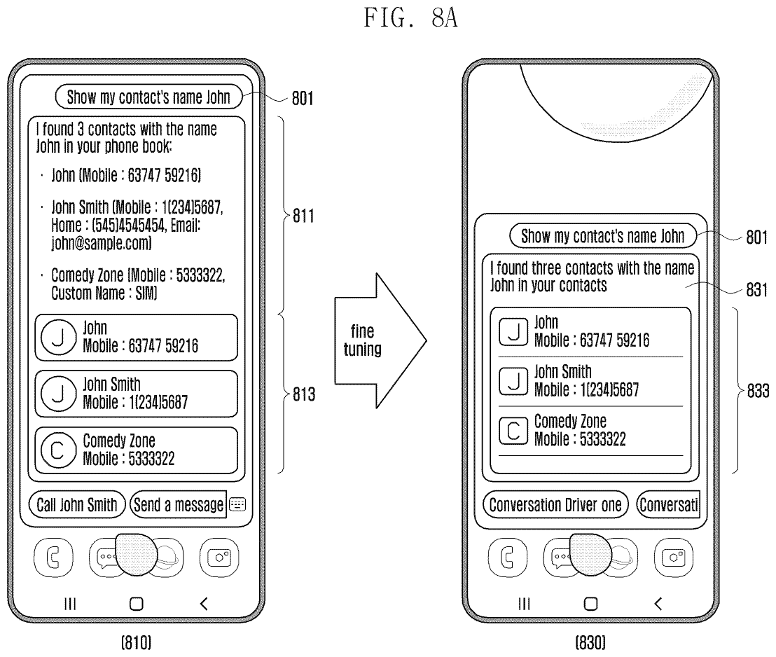

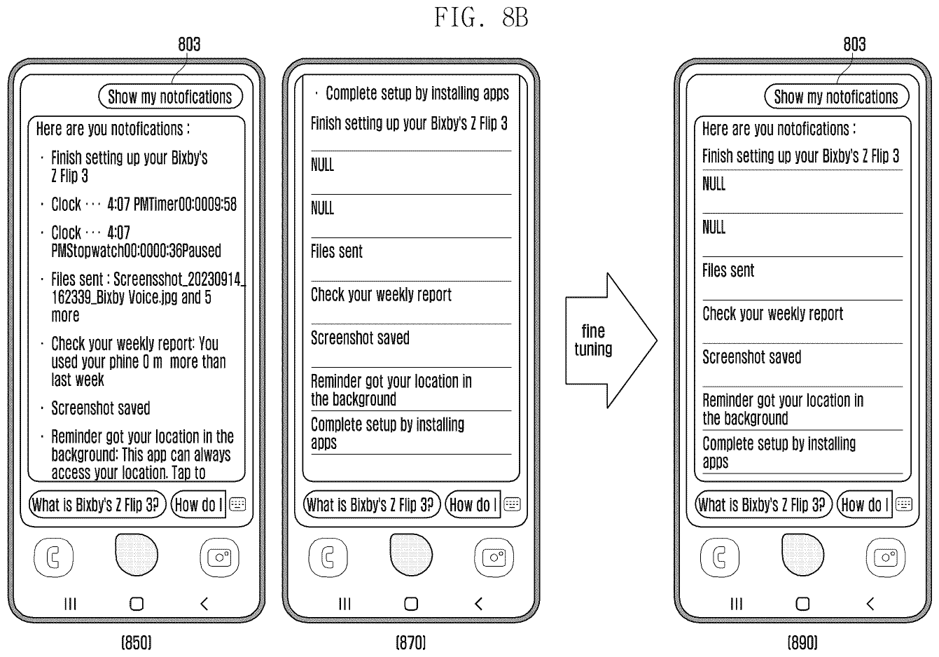

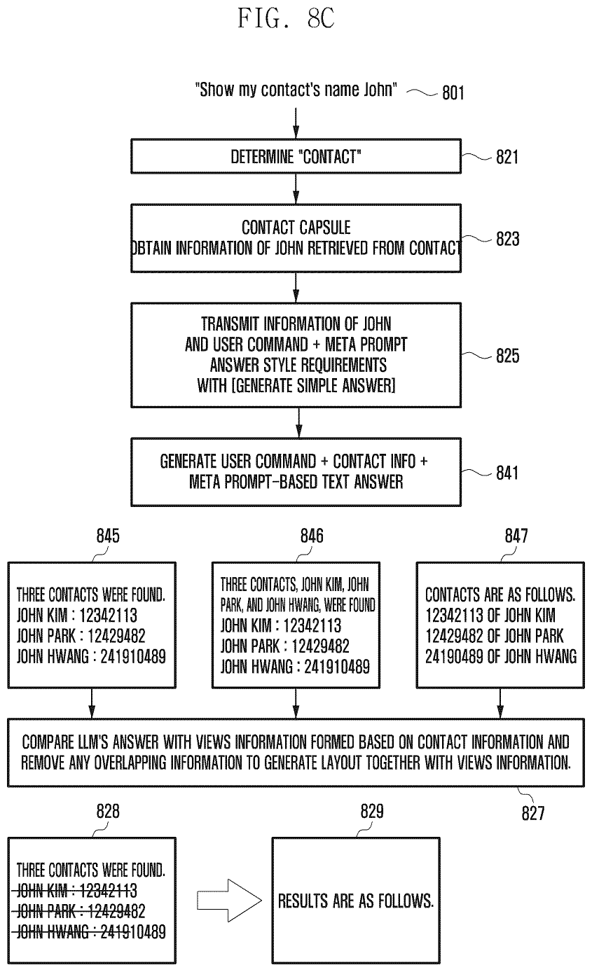

According to an embodiment, the processor 120 may analyze the search result to determine the answer type, distinguish between display text (e.g., 870 in FIG. 8B) and read text (e.g., 850 in FIG. 8B) based on the answer type, and classify the answer into a first answer and a second answer by removing the read text. The processor 120 may classify the answer into the first answer and the second answer by removing the read text, reflecting the user's needs. On the other hand, the answer may be classified into the first answer and the second answer by removing the display text.

The display text and the read text may have different text lengths. For example, if the text included in the read text is 20 characters long, the text included in the display text may be 100 characters or longer. The read text is text read aloud by the electronic device 101 and may be generated simpler than the display text. The display text refers to text displayed on the screen of the electronic device 101 and may include more detailed information than the display text. When transmitting the user query to the server 108, the processor 120 may request that the type of text be distinguished and transmitted (e.g., meta prompt), or may analyze the server search result to determine the answer type of the text.

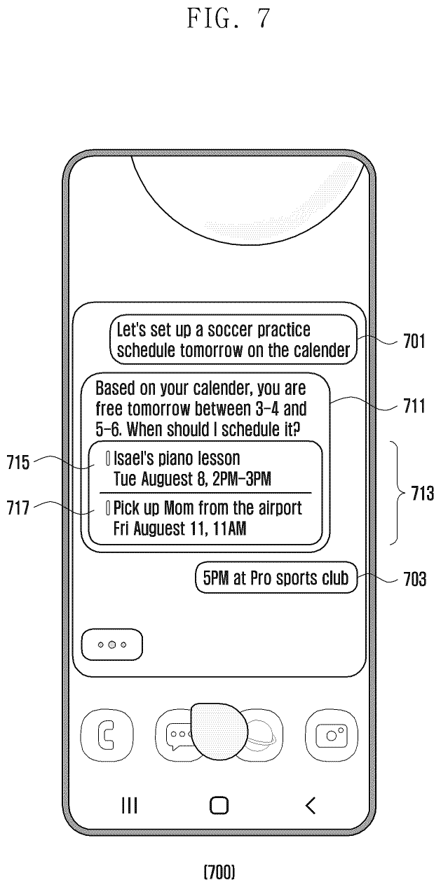

FIG. 7 is a diagram illustrating an example of classifying answers to a user query into a first answer and a second answer and providing them in an electronic device according to an embodiment of the disclosure.

Referring to FIG. 7, a processor (e.g., the processor 120 in FIG. 1) of an electronic device (e.g., the electronic device 101 in FIG. 1) according to an embodiment may display a user interface 700 including answers 711 and 713 corresponding to a first user query 701 on a display (e.g., the display module 160). The processor 120 may extract keywords from the first user query 701 and retrieve information stored on the electronic device 101 or an external device (e.g., an IoT device) that uses the same user account as the electronic device 101, using the extracted keywords. The processor 120 may transmit the first user query 701 and/or the retrieved information (e.g., a device search result) to an intelligent server (e.g., the server 108 in FIG. 1) via a communication module (e.g., the communication module 190 in FIG. 1). The device search result may include information retrieved from the memory 130 of the electronic device 101, a cloud server registered with a user account of the electronic device 101, or an external device, based on the user query or keywords extracted from the user query.

The processor 120 may receive a server search result from the server 108 and remove information (e.g., removing duplicate text) that overlaps with the device search result from the server search result, thereby generating a first answer 711 and a second answer 713. The processor 120 may configure the text answer generated by the server 108 as the first answer 711 and configure schedule information generated based on the information stored on the electronic device 101 as the second answer 713. The second answer 713 may include first schedule information 715 and second schedule information 717. The processor 120 may classify the search result into the first answer 711 and the second answer 713 using an answer reconstruction model. The processor 120 may use the answer reconstruction model to summarize the text generated by the server 108 and construct the first answer 711.

The answer reconstruction model may be generated by learning a user query, an answer, and an additional user response. The processor 120 may collect a user query, an answer displayed in response to the user query, and an additional user response to the answer, and learn the collected user query, the collected answer, and the additional user response, thereby generating the answer reconstruction model. When a new user query is received, the processor 120 may update the answer reconstruction model. The processor 120 may update the answer reconstruction model based on the new user query, the answer to the new user query, and the additional user response.

According to an embodiment, the user interface 700 may further include an object (e.g., a button) for outputting voice for the first answer 711 and/or the second answer 713. When the user selects a voice output object, the processor 120 may convert the text of the first answer 711 or/and the second answer 713 into voice and output the converted voice through a speaker (e.g., the audio output module 155 in FIG. 1) or an external speaker (e.g., earphones connected to the electronic device 101).

The processor 120 may receive a second user query 703 from the user who has identified the first answer 711 and/or the second answer 713. The processor 120 may add (or register) the “5 o'clock sports club” schedule to the schedule application, based on the second user query 703.

FIGS. 8A and 8B are diagrams illustrating an example of comparing an answer obtained from a server with a displayed answer in an electronic device according to various embodiments of the disclosure.

Referring to FIG. 8A, a processor (e.g., the processor 120 in FIG. 1) of an electronic device (e.g., the electronic device 101 in FIG. 1) according to an embodiment may receive a first user query 801 and receive search results 811 and 813 corresponding to the first user query 801 from an intelligent server (e.g., the server 108 in FIG. 1). A first user interface 810 illustrates an example of providing search results 811 and 813 in a comparative example. In the search results 811 and 813, the text of the first search result 811 and the second search result 813 may partially overlap. The first search result 811 may be content generated by the server 108, and the second search result 813 may be content retrieved by the electronic device 101.

The processor 120 may use an answer reconstruction (fine-tuning) model to configure the search results 811 and 813 into a first answer 831 and a second answer 833. A second user interface 830 may include the first user query 801, the first answer 831, and the second answer 833, according to the disclosure. The first answer 831 may be obtained by removing duplicate text (e.g., part of the first search result 811) from the search results 811 and 813 and retaining the remaining text. The second answer 833 corresponds to the second search result 813 and may include information retrieved from a contact application of the electronic device 101. The processor 120 may reconstruct the search results 811 and 813 into a first answer 831 in a text type and a second answer 833 in a view type.

As a criterion for distinguishing the first answer and the second answer, the second answer may be information retrieved from the application of the electronic device 101 based on a request from the server 108, and displayed in a specific format. The first answer may be an answer generated in natural language based on information retrieved from the application in response to a request from the server 108.

Referring to FIG. 8B, the processor 120 may receive a second user query 803 and receive a search result corresponding to the second user query 803 from the server 108. The third user interface 850 and the fourth user interface 870 illustrate examples of providing search results in the comparative example. The processor 120 may display a fourth user interface 870 upon detecting a user's scroll input on the third user interface 850. The content included in the third user interface 850 and the content included in the fourth user interface 870 may have some text overlapping. The content included in the third user interface 850 may be content generated by the server 108, and the content included in the fourth user interface 870 may be content retrieved from the electronic device 101.

The processor 120 may configure a fifth user interface 890 using an answer reconstruction model. According to the disclosure, the fifth user interface 890 may include the second user query 803 and an answer with duplicate information removed. The processor 120 may determine whether there is duplicate text (e.g., a portion of the third user interface 850) between the content included in the third user interface 850 and the content included in the fourth user interface 870. The processor 120 may remove the duplicate text (e.g., a portion of the third user interface 850) and maintain the remaining text to construct an answer to the second user query 803, as shown in the fifth user interface 890.

FIG. 8C is a diagram illustrating an example of reconstructing an answer obtained from a server in an electronic device according to an embodiment of the disclosure.

Referring to FIG. 8C, when a user query 801 “Find John in the phone book,” the processor 120 may analyze the user query 801 to determine a contact application in operation 821. The processor 120 may obtain contact information retrieved for the name “John” from the contact application in operation 823, and transmit the obtained contact information and the user query to the server 108 in operation 825. At this time, the processor 120 may send a desired answer style to the server 108 as a meta prompt.

The server 108 may generate an answer (or server search result) based on the user query 801, the contact information, and the meta prompt in operation 841. For example, the server 108 may generate at least one of a first answer text 845, a second answer text 846, or a third answer text 847. When at least one of the first answer text 845, the second answer text 846, or the third answer text 847 is received from the server 108, the processor 120 may compare the received text with view information formed based on the contact information, remove duplicate information, and form an answer layout together with the view information in operation 827. For example, the processor 120 may remove the contact information to generate a 1-1st answer 828 or a 1-2nd answer 829. The processor 120 may provide the 1-1st answer 828 or the 1-2nd answer 829 as a first answer, and the contact information as a second answer.

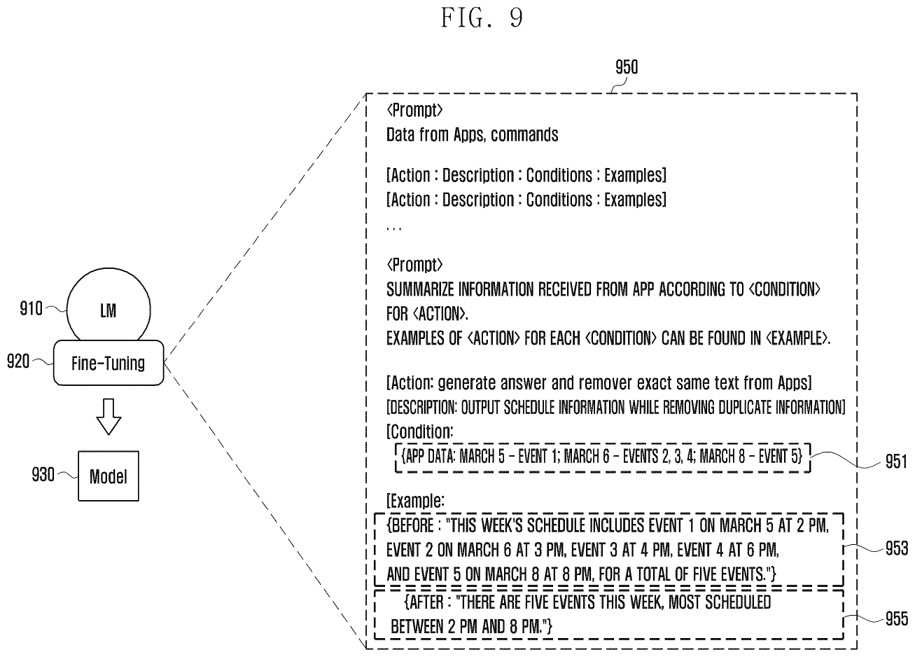

FIG. 9 is a diagram illustrating an example of processing and providing an answer obtained from a server in an electronic device according to an embodiment of the disclosure.

Referring to FIG. 9, a processor (e.g., the processor 120 in FIG. 1) of an electronic device (e.g., the electronic device 101 in FIG. 1) according to an embodiment may generate an answer reconstruction model 930 using a search result 910 received from an intelligent server (e.g., server 108 in FIG. 1) and a reconstructed answer 920. The answer reconstruction model 930 may be generated by learning a user query, an answer, and an additional user response. The processor 120 may collect a user query, an answer displayed in response to the user query, and an additional user response to the answer, and learn the collected user query, the collected answer, and the collected additional user response, thereby generating an answer reconstruction model 930. When a new user query is received, the processor 120 may update the answer reconstruction model. The processor 120 may update the answer reconstruction model, based on a new user query, an answer to the new user query, and an additional user response.

Referring to a prompt 950, upon receiving a user query, the processor 120 may extract keywords from the user query and, based on the keywords, obtain a device search result 951 from an application installed on the electronic device 101. The device search result 951 may include information retrieved from the memory 130 of the electronic device 101, a cloud server registered with the user account of the electronic device 101, or an external device, based on the user query or the keywords extracted from the user query.

Alternatively, the processor 120 may analyze the user query to determine a domain (e.g., an application) corresponding to the user query, and retrieve information associated with the user query from the determined application. Additionally, the device search result 951 may include information retrieved from information stored (or registered) in an external device connected (or having been previously connected) to the electronic device 101 or an external device using the same user account, using the keywords. The processor 120 may transmit the user query and/or the device search result 951 to the server 108 and receive a server search result 953 from the server 108. The server search result 953 is merely simplified to aid understanding of the disclosure and may include a greater amount of information than illustrated. The server search result 953 is generated by the server 108, and the processor 120 may generate an answer 955 to be provided to the user by summarizing the server search result 953. Comparing the server search result 953 and the answer 955, it may be seen that the answer 955 is generated to make the server search result 953 easier for the user to view and understand.

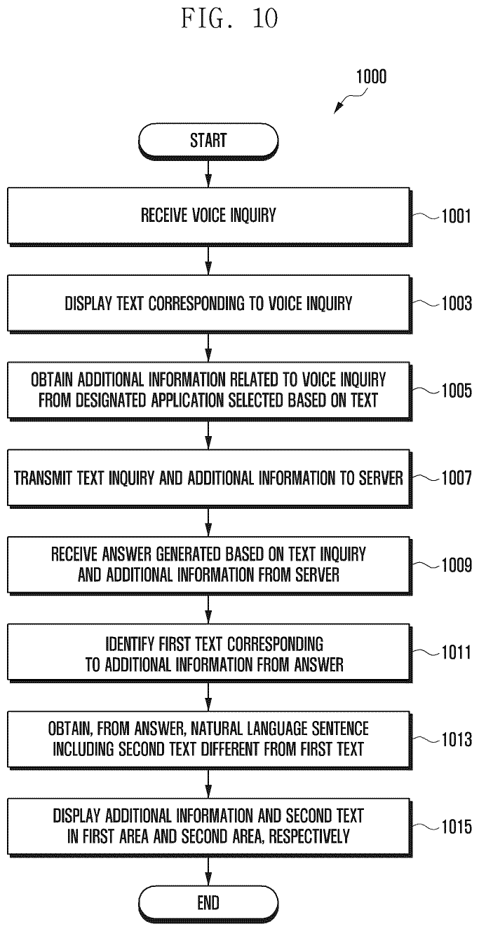

FIG. 10 is a flowchart 1000 illustrating a method of reconstructing an answer obtained from a server in an electronic device according to an embodiment of the disclosure.

Referring to FIG. 10, in operation 1001, a processor (e.g., the processor 120 in FIG. 1) of an electronic device (e.g., the electronic device 101 in FIG. 1) according to an embodiment may receive a voice inquiry. The voice inquiry is an input received (or obtained) from a user, and may include, for example, not only a question (in the form of an interrogative sentence), but also a request, a list of simple words, and/or a combination thereof. The processor 120 may receive the voice inquiry via a microphone (e.g., the input module 150 in FIG. 1).

In operation 1003, the processor 120 may display text corresponding to the voice inquiry on a display (e.g., the display module 160 in FIG. 1). The processor 120 may display text corresponding to the voice inquiry on an execution screen corresponding to a voice assistant application.

In operation 1005, the processor 120 may obtain additional information related to the voice inquiry from a designated application selected based on the text. The processor 120 may obtain a text inquiry including at least a part of the voice inquiry and additional information related to the voice inquiry from a designated application other than the voice assistant application, which is selected based on the text. The other designated application may correspond to an application other than the voice assistant application, such as a contact application or a scheduler.

In operation 1007, the processor 120 may transmit the text inquiry and the additional information to an intelligent server (e.g., the server 108 in FIG. 1). The processor 120 may transmit the text inquiry and the additional information to the server 108 via a communication circuit (e.g., the communication module 190 in FIG. 1).

In operation 1009, the processor 120 may receive an answer generated based on the text inquiry and the additional information from the server 108. The server 108 may include an LLM server or an artificial intelligence server employing large language model technology. The server 108 may retrieve the text inquiry and the additional information and generate an answer based on the retrieved information. The server 108 may transmit the generated answer (e.g., a server search result) to the electronic device 101. The processor 120 may receive the answer from the server 108 via the communication module 190.

In operation 1011, the processor 120 may identify a first text corresponding to the additional information from the answer.

In operation 1013, the processor 120 may obtain a natural language sentence including a second text, which is different from the first text, from the answer.

In operation 1015, the processor 120 may display the additional information and the second text in the first area and the second area, respectively. The processor 120 may display the additional information and the second text in the first area and the second area, respectively, which are separated from each other on the execution screen of the voice assistant application through the display. The processor 120 may display the second area, where the second text is displayed, above the first area, where the additional information is displayed.

According to an embodiment, the processor 120 may display, as a part of the additional information, at least one image or at least one piece of detailed information corresponding to the name of at least one item included in the first text. The processor 120 may display, as a part of the second text, text obtained by summarizing detailed information other than the name of at least one item. The processor 120 may display text indicating the number of at least one item as a part of the second text. The processor 120 may display the additional information and the second text in different first and second formats, respectively. The processor 120 may output audio corresponding to the second text to the outside of the electronic device at least once while the second text is displayed.

The designated application may include a scheduler, and the processor 120 may transmit a user's schedule information, which is obtained through the scheduler and satisfies a specific condition included in the voice inquiry, to the server 108 as at least a part of the additional information, and display text obtained by summarizing the schedule information as a part of the second text.

According to an embodiment, the processor 120 may receive a voice inquiry including a first intent and a second intent through a microphone 150, display, through the display, text corresponding to the voice inquiry in a first area of an execution screen corresponding to the first application, transmit a text inquiry including at least a part of the text to the server through the communication circuit, receive an answer generated based on the user inquiry from the server through the communication circuit, identify a first answer part corresponding to the first intent and a second answer part corresponding to the second intent from the answer, and, in response to the voice inquiry, display the first answer part in a second area of the execution screen located below the first area, and the second answer part in a third area of the execution screen located below the second area.

According to an embodiment, the processor 120 may display the first answer part and the second answer part through the second area and the third area, respectively, based at least in part on the first answer part not requesting additional information related to the voice inquiry and the second answer part requesting the additional information.

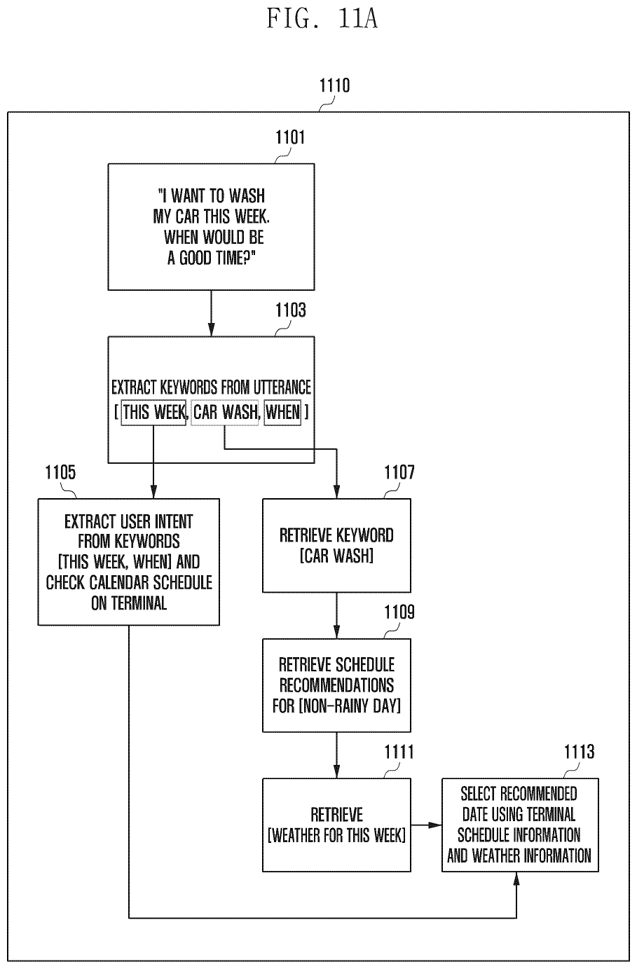

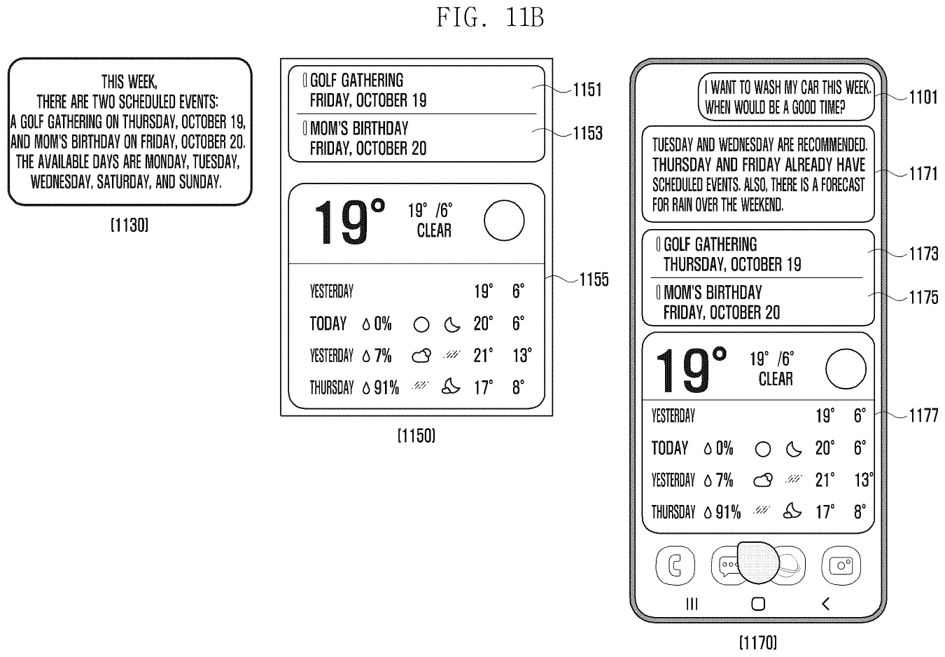

FIG. 11A is a diagram 1110 illustrating an example of extracting a keyword from a user query and performing a search in an electronic device and a server according to an embodiment of the disclosure.

Referring to FIG. 11A, a processor (e.g., the processor 120 in FIG. 1) of an electronic device (e.g., the electronic device 101 in FIG. 1) according to an embodiment may receive a user query 1101 and perform an operation 1103 of extracting keywords (e.g., this week, car wash, and when) from the user query 1101. The processor 120 may extract a user intent from the keywords such as “this week” and “when” and perform an operation 1105 of retrieving (or searching for) schedules from a schedule application. When schedule information is retrieved from the schedule application, the processor 120 may transmit the retrieved schedule information (e.g., a device search result) and the user query 1101 to an intelligent server (e.g., the server 108 in FIG. 1). The device search result may include information retrieved from the memory 130 of the electronic device 101, a cloud server registered with the user account of the electronic device 101, or an external device, based on the user query or the keywords extracted from the user query. Furthermore, the processor 120 may recognize the user intent from the user query 1101 and retrieve weather information from a weather application. Alternatively, the processor 120 may analyze a search result received from the server 108 and retrieve weather information from the weather application.

The server 108 may receive the user query 1101 and the schedule information, and perform an operation 1107 of retrieving the keyword “car wash.” Based on the schedule information, the server 108 may retrieve a “non-rainy day” schedule in operation 1109 and retrieve this week's weather in operation 1111. The server 108 may select (or determine) a recommended date for car washing, based on the schedule information and the weather information in operation 1113. The server 108 may transmit a search result, including the recommended date, to the electronic device 101.

FIG. 11B is a diagram illustrating an example of a user interface providing an answer to a user query in an electronic device according to an embodiment of the disclosure.

Referring to FIG. 11B, the processor 120, based on a search result, may display a user interface 1170 including a user query 1101, and a first answer 1171 and second answers 1173, 1175, and 1177 corresponding to the user query 1101 on a display (e.g., the display module 160 in FIG. 1). The search result 1130 may be generated by the server 108. An application-based information 1150 may include a device search result retrieved by the processor 120 using keywords or information obtained by analyzing the search result. The device search result may include information retrieved from the memory 130 of the electronic device 101, a cloud server registered with the user account of the electronic device 101, or an external device, based on the user query or the keywords extracted from the user query.

The application-based information 1150 may include first schedule information 1151, second schedule information 1153, and weather information 1155. The processor 120 may determine whether there is content overlapping between the search result 1130 and the application-based information 1150. The processor 120 may generate a first answer 1171 by removing the text overlapping between the text of the search result 1130 and the text of the application-based information 1150. The processor 120 may summarize the search result 1130 to configure the first answer 1171. Furthermore, the processor 120 may generate second answers 1173, 1175, and 1177 based on the application-based information 1150. The processor 120 may include the first schedule information 1151, the second schedule information 1153, and the weather information 1155 included in the application-based information 1150 in the second answers 1173, 1175, and 1177.

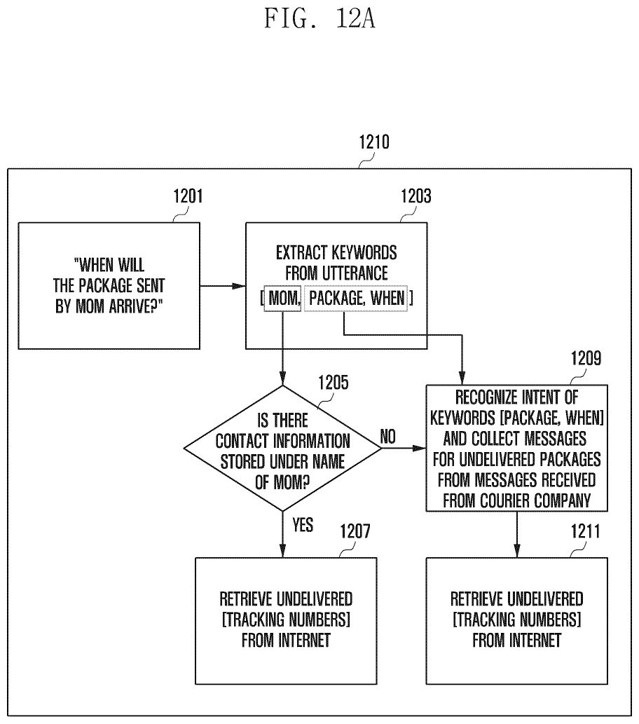

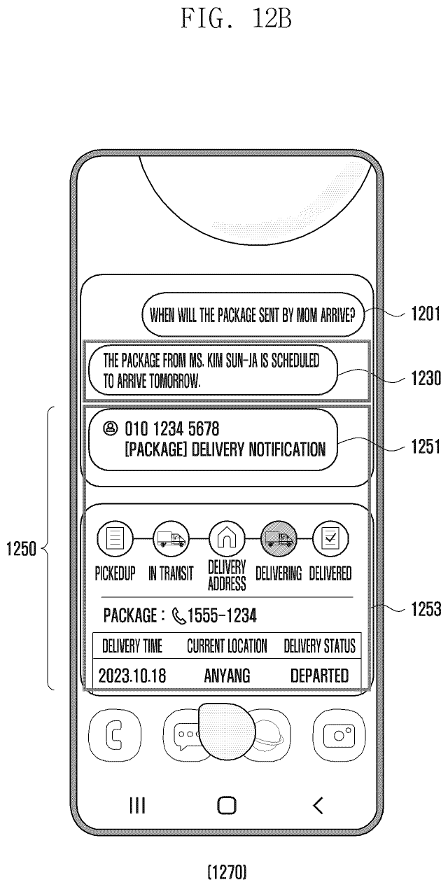

FIG. 12A is a diagram 1210 illustrating an example of extracting a keyword from a user query and performing a search in an electronic device and a server according to an embodiment of the disclosure.

Referring to FIG. 12A, a processor (e.g., the processor 120 in FIG. 1) of an electronic device (e.g., the electronic device 101 in FIG. 1) according to an embodiment may receive a user query 1201 and perform an operation 1203 of extracting keywords (e.g., “mom,” “package,” and “when”) from the user query 1201. The processor 120 may perform an operation 1205 of retrieving (or searching for) a phone number stored under the name “Mom” from a contact application to determine whether there is a contact stored under the keyword “Mom.” When contact information is retrieved from the contact application, the processor 120 may transmit the retrieved contact information (e.g., a device search result) and the user query 1201 to an intelligent server (e.g., the server 108 in FIG. 1). Alternatively, the processor 120 may retrieve messages exchanged with Mom from a messaging (or messenger) application. The device search result may include information retrieved from the memory 130 of the electronic device 101, a cloud server registered with the user account of the electronic device 101, or an external device, based on the user query or the keywords extracted from the user query.

When contact information is retrieved, the processor 120 may query whether there are any undelivered packages in operation 1207. Alternatively, if contact information is not retrieved, the processor 120 may recognize a user intent from the user query 1201 and retrieve (or collect) messages for undelivered packages from the messaging application (or shopping application) in operation 1209. Alternatively, the processor 120 may analyze a search result received from the server 108 to retrieve messages from the messaging application (or shopping application).

The server 108 may receive the user query 1201, contact information, and/or message content, and perform an operation 1211 of retrieving the tracking number for undelivered packages. The server 108 may analyze the message content to retrieve the tracking number for undelivered packages. The server 108 may transmit a search result to the electronic device 101.

FIG. 12B is a diagram illustrating an example of a user interface providing an answer to a user query in an electronic device according to an embodiment of the disclosure.

Referring to FIG. 12B, the processor 120, based on a search result, may display a user interface 1270 including a user query 1201, and a first answer 1230 and a second answer 1250 corresponding to the user query 1201 on a display (e.g., the display module 160 in FIG. 1). The first answer 1230 may be obtained by the processor 120 reconstructing (e.g., summarizing) the text created by the server 108. The second answer 1250 may include application-based information. For example, the second answer 1250 may include a message 1251 and a delivery information image 1253. The message 1251 may be obtained directly from the messaging application, or may be a message content reconstructed (e.g., summarized) by the processor 120. Furthermore, the delivery information image 1253 may be obtained by capturing the image obtained from the shopping application, or may be a delivery information image reconstructed (e.g., generated) by the processor 120.

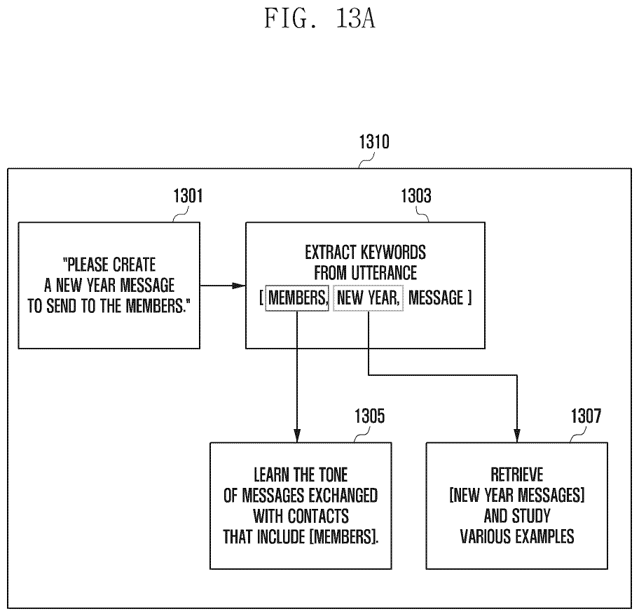

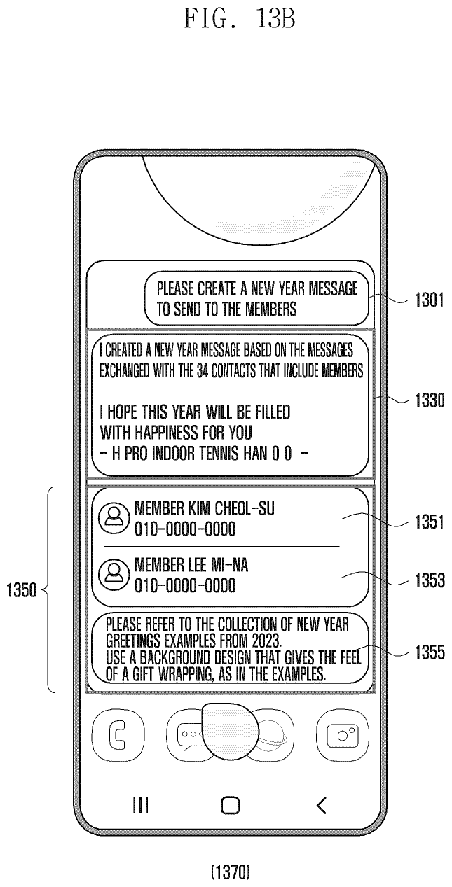

FIG. 13A is a diagram 1310 illustrating an example of extracting a keyword from a user query and performing a search in an electronic device and a server according to an embodiment of the disclosure.

Referring to FIG. 13A, a processor (e.g., the processor 120 in FIG. 1) of an electronic device (e.g., the electronic device 101 in FIG. 1) according to an embodiment may receive a user query 1301 and perform an operation 1303 of extracting keywords (e.g., “member,” “New Year,” and “text”) from the user query 1301. The processor 120 may perform an operation 1305 of retrieving (or searching for) a phone number stored under the name “member” form a contact application to determine whether there is a contact information stored under the keyword “member.” Alternatively, the processor 120 may retrieve messages sent under the name “member” from a messaging (or messenger) application. The processor 120 may transmit the retrieved contact information or message (e.g., a device search result) along with the user query 1301 to an intelligent server (e.g., the server 108 in FIG. 1). The processor 120 may learn 1307 a search result retrieved using the keyword “New Year text.” The device search result may include information retrieved from the memory 130 of the electronic device 101, a cloud server registered under the user account of the electronic device 101, or an external device, based on the user query or the keywords extracted from the user query.

The server 108 may receive the user query 1301, the contact information, or/and the message content, and perform an operation 1307 of performing a search using “New Year” and “text.” The server 108 may analyze the contact information and the message content to select (or identify) a recipient to whom a New Year's message will be sent. The server 108 may transmit the search result to the electronic device 101.

FIG. 13B is a diagram illustrating an example of a user interface providing an answer to a user query in an electronic device according to an embodiment of the disclosure.

Referring to FIG. 13B, the processor 120, based on a search result, may display a user interface 1370 including a user query 1301, and a first answer 1330 and a second answer 1350 corresponding to the user query 1301 on a display (e.g., the display module 160 in FIG. 1). The first answer 1330 may be obtained by the processor 120 reconstructing (e.g., summarizing) the text created by the server 108. The second answer 1350 may include a search result of the server 108 and application-based information. For example, the second answer 1350 may include first contact information 1351, second contact information 1353, and a New Year's message list 1355. The first contact information 1351 and second contact information 1353 may be obtained directly from the contact application, or may be obtained by the processor 120 reconstructing (e.g., summarizing) contact information. Furthermore, the New Year's message list 1355 may be an answer inferred by the server 108.

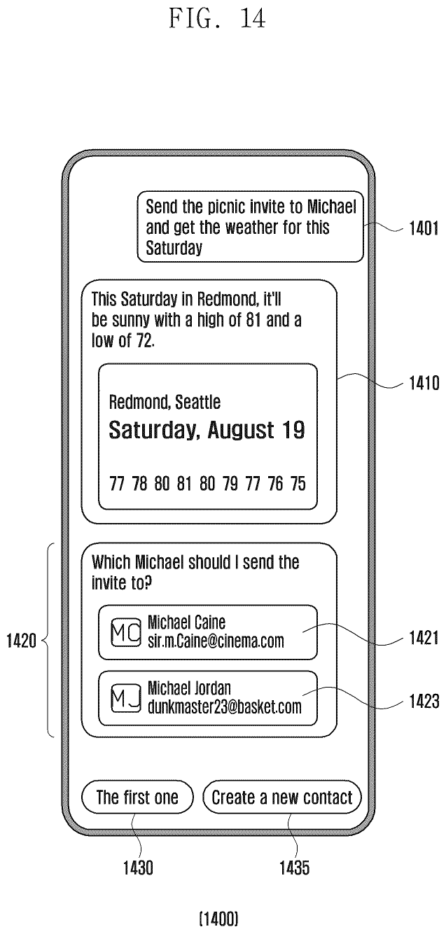

FIG. 14 is a diagram illustrating an example of adjusting the order of answers to a user query in an electronic device according to an embodiment of the disclosure.

Referring to FIG. 14, a processor (e.g., the processor 120 in FIG. 1) of an electronic device (e.g., the electronic device 101 in FIG. 1) according to an embodiment may display a user interface 1400 including a first answer 1410 and a second answer 1420 in response to a user query 1401 on a display (e.g., the display module 160 in FIG. 1). The first answer 1410 may be obtained by the processor 120 reconstructing (e.g., summarizing or generating) a search result obtained from an intelligent server (e.g., the server 108 in FIG. 1). The processor 120 may extract keywords from the user query 1401 and retrieve a calendar application or schedule application using the extracted keywords. The processor 120 may transmit the user query 1401 and retrieved information to the server 108.

The processor 120 may analyze the user query 1401 to identify a user intent and, based on the identified user intent, identify whether an additional user response is requested from the search result. The processor 120 may configure an answer for which an additional user response is not requested as the first answer 1410 and an answer for which an additional user response is requested as the second answer 1420. For example, the processor 120 may reconstruct the search result received from the server 108 to configure the first answer 1410 including text and calendar information. The processor 120 may configure an answer requiring an additional user response in the search result as the second answer 1420.

If the name of the other party included in the user query 1401 is not specified as a single person, the processor 120 may request an additional response from the user. The second answer 1420 may include first contact information 1421 and second contact information 1423, and may include a question regarding which of the two contacts the message should be sent to. Furthermore, the processor 120 may provide execution items 1430 and 1435 for the additional user response to the second answer 1420. When the first execution item 1430 is selected by the user, the processor 120 may execute a messaging application and set the recipient as the other party of the first contact information 1421 on the execution screen of a messaging application. Alternatively, when the second execution item 1435 is selected by the user, the processor 120 may execute the contact application and position the cursor in the name field on the execution screen of the contact application.

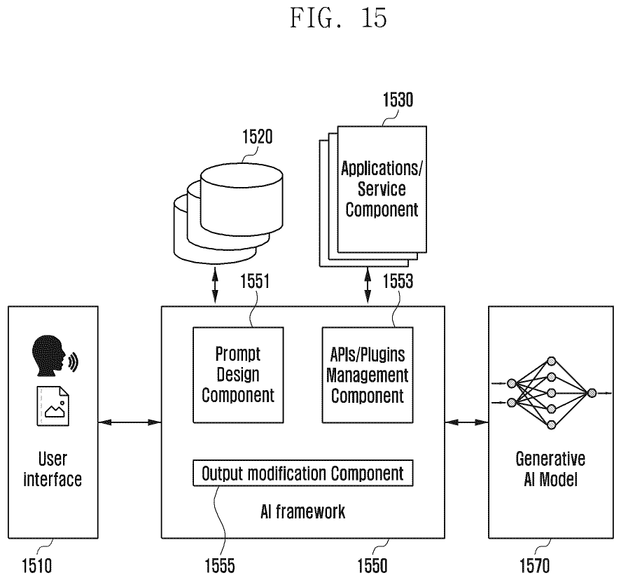

FIG. 15 is a block diagram illustrating an example of a generative artificial intelligence system according to an embodiment of the disclosure.

Referring to FIG. 15, a generative artificial intelligence system (e.g., an intelligent server or the server 108 in FIG. 1) according to an embodiment may include a user interface 1510, a database 1520, application and service components 1530, an AI framework 1550, and a generative AI model 1570.

The user interface 1510 may receive an input of a user query. The user query may have the form of natural language, images, and videos. In addition, when the user makes a query, context information may be transmitted together. As another example, the user query can be an unnatural input that does not generate natural language such as a design request or a modification. In addition, a mixed form of the above-described natural language, image, sound, and context information is also possible. Moreover, the user interface 1510 may output the result of the generative artificial intelligence system to the user. The output may be in the form of natural language or a specific content, and may also be provided in the form of an action requested by the user.

The AI framework 1550 may receive an input of the user query, and coordinate and control each component necessary to perform the user's intention. The AI framework 1550 may include a prompt design component 1551, an application programming interface and plugin (API/plugin) management component 1553, and an output modification component 1555.

The user query or action input through the user interface 1510 may be transmitted to the prompt design component 1551. The prompt design component 1551 may be used to generate a prompt suitable for the input into a large language model (LLM) or large multimodal models. The prompt design component 1551 may be an AI component that uses machine learning algorithms or neural networks to develop better prompts as time passes. The prompt design component 1551 may access a knowledge component including user preference data, a prompt library, and prompt examples to generate a prompt and transfer the same to a large language model (LLM) or a large multi-modal model (LMM).

The application and plugin management component 1553 may serve to perform communicating with external information if there is a request for additional information when a user input is transferred as the input of the generative model. The application and plugin management component 1553 may construct a channel capable of communicating with the outside of the AI interface through an application programming interface (API), thereby allowing access to various data sources. In addition, when an action for performing the user query rather than the intermediate result should be finally performed by an application or a service, the application and plugin management component 1553 may make a request for the corresponding action through an API. The information secured from the outside may be transferred as the input of the generative model together with the user input.

The output modification component 1555 may finely tune the result output from the generative model. For example, the output modification component 1555 may verify whether the content generated through a language model (LLM) or a large-scale multimodal model (LMM) is irrelevant, includes biased content, or includes harmful content. In addition, the output modification component 1555 may determine to which extent the output conforms to a desired result of the user, and if an additional process is needed, perform the corresponding process. Additionally, the output modification component 1555 may configure a hint for avoiding an unintended output and provide the same to the user.

The generative AI model 1570 generally refers to an artificial intelligence neural network that makes new types of data, depending on user input information. Typical models for generating images include a generative adversarial network (GAN) and a variational auto encoder (VAE), and recently, a diffusion-based generative model using a VAE and a Transformer structure is referred to as a generative model. In addition, the language model is a model trained to output the most appropriate output value statistically based on the input value, and examples thereof representatively include models such as CHAT-GPT 3 and CHAT-GPT 4. Moreover, the model may recognize various types of data inputs, such as text, images, and sounds, and generate new data in response thereto, and thus is called a large multimodal model (LMM).

An operating method of an electronic device 101 according to an embodiment of the disclosure may include receiving a voice inquiry through a microphone 150 of the electronic device, displaying text corresponding to at least a part of the voice inquiry on an execution screen corresponding to a voice assistant application via a display 160 of the electronic device, transmitting a text inquiry including at least a portion of the text and additional information related to the voice inquiry and obtained from a designated application other than the voice assistant application, which is selected based on the text, to a server 108 via a communication circuit 190 of the electronic device, receiving an answer generated based at least in part on the text inquiry and the additional information from the server via the communication circuit, identifying a first text corresponding to the additional information from the answer, obtaining a first answer part including a second text, which is different from the first text, from the answer, and, in response to the voice inquiry, displaying the first answer part and a second answer part corresponding to the additional information in separate first and second areas, respectively, on the execution screen via the display.

The displaying of the first and second answer parts, respectively, may include displaying the first area, where the first answer part is displayed, above the second area where the second answer part is displayed.

The displaying of the first and second answer parts, respectively, may include displaying at least one image or at least one piece of detailed information corresponding to a name of at least one item included in the first text as a part of the second answer part.

The displaying of the first and second answer parts, respectively, may include displaying text obtained by summarizing detailed information other than the name of the at least one item as a part of the first answer part.

The displaying of the first and second answer parts, respectively, may include displaying text indicating the number of the at least one item as a part of the first answer part.

The displaying of the first and second answer parts, respectively, may include displaying the first answer part and the second answer part in different formats, respectively.

The displaying of the first and second answer parts, respectively, may include outputting audio corresponding to at least a portion of the first answer part at least once to the outside of the electronic device while the first answer part is displayed.

The designated application may include a scheduler, and the displaying of the first and second answer parts, respectively, may include transmitting a user's schedule information obtained through the scheduler, which satisfies a specific condition included in the voice inquiry, to the server as at least a portion of the second answer part, and displaying text obtained by summarizing the schedule information as a portion of the first answer part.

An operating method of an electronic device 101 according to an embodiment of the disclosure may include receiving a voice inquiry including a first intent and a second intent through a microphone 150, displaying text corresponding to the voice inquiry in a first area of an execution screen corresponding to the first application through the display, transmitting a text inquiry including at least a portion of the text to the server through a communication circuit 190 of the electronic device, receiving an answer generated based on the user inquiry from the server through the communication circuit, identifying a first answer part corresponding to the first intent and a second answer part corresponding to the second intent from the answer, and, in response to the voice inquiry, displaying the first answer part in a second area of the execution screen located below the first area, and the second answer part in a third area of the execution screen located below the second area.

The method may further include displaying the first answer part and the second answer part through the second area and the third area, respectively, based at least in part on the first answer part not requesting additional information related to the voice inquiry and the second answer part requesting the additional information.

One or more non-transitory computer-readable storage media storing one or more computer programs including computer-executable instructions that, when executed by one or more processors of an electronic device individually or collectively, cause the electronic device to perform operations are provided. The operations include receiving, by the electronic device, a voice inquiry through a microphone of the electronic device, displaying, by the electronic device, text corresponding to at least a part of the voice inquiry on an execution screen corresponding to a voice assistant application via a display of the electronic device, transmitting, by the electronic device, a text inquiry including at least a portion of the text and additional information related to the voice inquiry and obtained from a designated application other than the voice assistant application, which is selected based on the text, to a server via a communication circuit of the electronic device, receiving, by the electronic device, an answer generated based at least in part on the text inquiry and the additional information from the server via the communication circuit, identifying, by the electronic device, a first text corresponding to the additional information from the answer, obtaining, by the electronic device, a first answer part including a second text, which is different from the first text, from the answer, and in response to the voice inquiry, displaying, by the electronic device, the first answer part and a second answer part corresponding to the additional information in separate first and second areas, respectively, on the execution screen via the display.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory comprising one or more storage media, storing instructions; and
one or more processors communicatively coupled to the display and the memory,
wherein the instructions, when executed by the one or more processors individually or collectively, cause the electronic device to:
extract a keyword from a user query received from a user,
retrieve information related to an application of the electronic device, based on the keyword, to provide the information as a device search result,
transmit the user query and the device search result to a server,
obtain a server search result related to the user query from the server,
generate a first answer by removing information that overlaps with information included in the device search result from the server search result,
generate a second answer based on the device search result, and
display the first answer and the second answer.

2. The electronic device of claim 1, wherein the instructions, when executed by the one or more processors individually or collectively, further cause the electronic device to obtain information, as the device search result, retrieved from an external device associated with the electronic device using the keyword.

3. The electronic device of claim 1, wherein the instructions, when executed by the one or more processors individually or collectively, further cause the electronic device to display the first answer and the second answer in separate first and second areas, respectively, on the display.

4. The electronic device of claim 3, wherein the instructions, when executed by the one or more processors individually or collectively, further cause the electronic device to display the first answer in the first area and display the second answer in the second area such that the first area is positioned above the second area on the display.

5. The electronic device of claim 1, wherein the instructions, when executed by the one or more processors individually or collectively, further cause the electronic device to:
analyze the user query to identify a user intent, and
based on a plurality of identified user intents, determine an order of answers in the server search result according to an order in which a user requested the answers.

6. The electronic device of claim 1, wherein the instructions, when executed by the one or more processors individually or collectively, further cause the electronic device to:
analyze the server search result to determine an answer type,
distinguish display text and read text, based on the answer type, and
remove the read text to generate the first answer.

7. The electronic device of claim 1, wherein the instructions, when executed by the one or more processors individually or collectively, further cause the electronic device to:
collect the user query, an answer displayed in response to the user query, and an additional user response to the answer, and
learn the collected user query, the collected answer, and the collected additional user response to generate an answer reconstruction model.

8. The electronic device of claim 7, wherein the instructions, when executed by the one or more processors individually or collectively, further cause the electronic device to generate the first answer and the second answer using the answer reconstruction model.

9. The electronic device of claim 7, wherein the instructions, when executed by the one or more processors individually or collectively, further cause the electronic device to update the answer reconstruction model when a new user query is received.

10. The electronic device of claim 1, wherein the instructions, when executed by the one or more processors individually or collectively, further cause the electronic device to:
generate the first answer as a natural language sentence, and
generate the second answer in a view type.

11. A method performed by an electronic device, the method comprising:
receiving, by the electronic device, a voice inquiry through a microphone of the electronic device;
displaying, by the electronic device, text corresponding to at least a part of the voice inquiry on an execution screen corresponding to a voice assistant application via a display of the electronic device;
transmitting, by the electronic device, a text inquiry comprising at least a portion of the text and additional information related to the voice inquiry and obtained from a designated application other than the voice assistant application, which is selected based on the text, to a server via a communication circuit of the electronic device;
receiving, by the electronic device, an answer generated based at least in part on the text inquiry and the additional information from the server via the communication circuit;
identifying, by the electronic device, a first text corresponding to the additional information from the answer;
obtaining, by the electronic device, a first answer part comprising a second text, which is different from the first text, from the answer; and
in response to the voice inquiry, displaying, by the electronic device, the first answer part and a second answer part corresponding to the additional information in separate first and second areas, respectively, on the execution screen via the display.

12. The method of claim 11, wherein the displaying of the first and second answer parts, respectively, comprises:
displaying the first area, where the first answer part is displayed, above the second area where the second answer part is displayed.

13. The method of claim 11, wherein the displaying of the first and second answer parts, respectively, comprises:
displaying at least one image or at least one piece of detailed information corresponding to a name of at least one item included in the first text as a part of the second answer part.

14. The method of claim 13, wherein the displaying of the first and second answer parts respectively comprises:
displaying text obtained by summarizing detailed information other than the name of the at least one item as a part of the first answer part.

15. The method of claim 13, wherein the displaying of the first and second answer parts respectively comprises:
displaying text indicating a total number of the at least one item as a part of the first answer part.

16. The method of claim 11, further comprising:
collecting the text inquiry, an answer displayed in response to the text inquiry, and an additional user response to the answer, and
learn the text inquiry, the answer displayed in response to the text inquiry, and the additional user response to the answer to generate an answer reconstruction model.

17. The method of claim 16, further comprising:
generating the first answer part and the second answer part using the answer reconstruction model.

18. The method of claim 16, further comprising:
updating the answer reconstruction model when a new text inquiry is received.

19. One or more non-transitory computer-readable storage media storing one or more computer programs including computer-executable instructions that, when executed by one or more processors of an electronic device individually or collectively, cause the electronic device to perform operations, the operations comprising:
receiving, by the electronic device, a voice inquiry through a microphone of the electronic device;
displaying, by the electronic device, text corresponding to at least a part of the voice inquiry on an execution screen corresponding to a voice assistant application via a display of the electronic device;
transmitting, by the electronic device, a text inquiry comprising at least a portion of the text and additional information related to the voice inquiry and obtained from a designated application other than the voice assistant application, which is selected based on the text, to a server via a communication circuit of the electronic device;
receiving, by the electronic device, an answer generated based at least in part on the text inquiry and the additional information from the server via the communication circuit;
identifying, by the electronic device, a first text corresponding to the additional information from the answer;
obtaining, by the electronic device, a first answer part comprising a second text, which is different from the first text, from the answer; and
in response to the voice inquiry, displaying, by the electronic device, the first answer part and a second answer part corresponding to the additional information in separate first and second areas, respectively, on the execution screen via the display.

20. The one or more non-transitory computer-readable storage media of claim 19, the operations further comprising:
displaying the first area, where the first answer part is displayed, above the second area where the second answer part is displayed.
